(19) United States
(12) Patent Application Publication
(10) Pub. No.: US 2026/0072587 A1
(43) Pub. Date: Mar. 12, 2026

(54) DISPLAY SCREEN OR PORTION THEREOF WITH GRAPHICAL USER INTERFACE AND SOCIAL MEDIA AND SYSTEMS AND METHODS OF CREATION AND USE OF VIRTUAL 3D OBJECTS AND OTHER NON-FUNGIBLE TOKENS

(71) Applicant: Hihve, LLC, Southlake, TX (US)

(72) Inventors: Walker Berryman, Southlake, TX (US); Ron Berryman, Southlake, TX (US)

(73) Assignee: Hihve, LLC, Southlake, TX (US)

(21) Appl. No.: 18/970,189

(22) Filed: Dec. 5, 2024

Related U.S. Application Data
(60) Provisional application No. 63/693,365, filed on Sep. 11, 2024.

(51) Int. Cl. G06F 3/0488; G06F 3/04815; G06F 3/0484; G06T 19/20

(52) U.S. Cl. CPC G06F 3/0488; G06F 3/04815; G06F 3/0484; G06T 19/20; G06F 2203/04804; G06T 2200/24; G06T 2210/32; G06T 2210/62; G06T 2219/2016

(57) ABSTRACT

A graphical user interface for a computer for displaying sports imagery, comprising: a visual screen; in computer memory at least one virtual object viewable within the screen, the virtual object having at least a virtual first external content surface and a virtual second external content surface which face different directions from each other. The virtual first external content surface has a first sports imagery. The virtual second external content surface has second sport imagery; virtual object is rotatable back and forth at least on a Z-axis and on an X-axis by the user in 3D within said viewable area to view different surfaces; wherein in response to user interface movement back and forth generally horizontally said virtual object rotates proportionally around said Z-axis; and, wherein in response to user interface movement back and forth generally vertically said virtual object rotates proportionally around said X-axis.

### CROSS-REFERENCE TO RELATED APPLICATION

This application claims the benefit of US Provisional Application No. 63/693,365 filed Sep. 11, 2024, which is hereby incorporated by reference.

### BACKGROUND OF THE INVENTION

The present invention relates to the use a platform and graphical user interface to facilitate the creation of non-fungible tokens and management for multiple purposes, including the name, image, and likeness (NILs) concerning sports and recruiting of athletes as well as sale, trade, and transfer of NFTs. Most athletes or users wishing to have an NFT displaying their own imagery are forced to outsource NFT creation. Many platforms do not properly facilitate users in making or managing their own imagery; are cumbersome to use; and are not robust, scalable, or reliable. Thus, there is a need for improvement in this field.

### SUMMARY OF THE INVENTION

This application relates to computer systems, including those for creating non-fungible tokens (NFTs) and other media for the purpose of housing and displaying imagery and information related to the name, image, and likeness (NIL) of certain figures including athletes. This disclosure enables users to use a platform which facilitates rendering virtual 3D objects, such as NFTs, and populating such objects with imagery and layout schemes selected by the user. The system and method can be used to help facilitate recruiting of athletes and the management and housing of media pertaining to persons such as athletes.

The present disclosure optionally but preferably includes methods and systems for rendering virtual 3D objects that are interactive. The present disclosure also includes a system and method for populating such virtual 3D objects and facilitating users to create, manage, and display such NFTs and NILs. The system includes templates for use in facilitating NFT creation. The virtual 3D object is movable to multiple positions and has interact media such as video and hyperlink.

The present application further discloses an interactive aspect of the system which pertains to social interactions and social media, including by athletes, recruiters, and other associated persons. The platform optionally but preferably allows end-users to interact with viewers and other users of the platform concerning their NFTs and virtual 3D objects, including for the purpose of recruiting for sports organizations or trading media and NFTs.

It also may be used and applied in virtually any other non-sports content including by way of non-limiting examples: medical records, business records, legal documents and information, architecture, and others. This field is all businesses and endeavors and is not be limited to other external industries (other than sports) listed herein.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a two-sided 3D template object. Note that the objects here and below are depicted in a screen around them, but such screen is not shown in FIGS. 1-19, but rather such objects depicted on the paper of this application is a proxy for such screen.

FIG. 2 is a perspective view of another face of a two-sided 3D template object.

FIG. 3 is a perspective view of a five-sided 3D template object.

FIG. 4 is a perspective view of a six-sided 3D template object.

FIG. 5 shows an embodiment of a 3D template object according to a certain orientation.

FIG. 6 shows an embodiment of a 3D template object according to a certain orientation.

FIG. 7 shows an embodiment of a 3D template object according to a certain orientation.

FIG. 8 shows an embodiment of a 3D template object according to a certain orientation.

FIG. 9 shows an embodiment of a 3D template object according to a certain orientation.

FIG. 10 shows an embodiment of a 3D template object according to a certain orientation.

FIG. 11 shows an embodiment of a 3D template object according to a certain orientation.

FIG. 12 shows an embodiment of a 3D template object according to a certain orientation.

FIG. 13 shows an embodiment of a 3D template object according to a certain orientation.

FIG. 14 shows an embodiment of a 3D template object according to a certain orientation.

FIG. 15 shows an embodiment of a 3D template object according to a certain orientation.

FIG. 16 shows an embodiment of a 3D template object according to a certain orientation.

FIG. 17 shows an embodiment of a 3D template object according to a certain orientation.

FIG. 18 shows an embodiment of a 3D template object according to a certain orientation.

FIG. 19 shows an embodiment of a 3D template object according to a certain orientation.

FIG. 20 is a flow chart of template creation for a user.

FIG. 21 is a view of a graphical user interface with a selection of templates for use in facilitating the creation of virtual 3D objects to show images and other media.

FIG. 22 is a view of a graphical user interface with a selection of further variables for use in creation of virtual 3D objects.

FIG. 23 shows an aspect of the graphical user interface in which an end use is prompted to choose amongst a selection of colors for use in a color scheme.

FIG. 24 shows an aspect of a graphical user interface where a user is enabled to choose from a selection of panel types for rendering a virtual 3D object.

FIG. 25 shows an aspect of a graphical user interface in which a user is enabled to provide further detail to panel types and media, including introduction, photos, and logos.

FIG. 26 shows further specifications within a graphical user interface, which are used to facilitate virtual 3D object rendering.

FIG. 27 is a chart related to template creation flow.

FIG. 28 is a chart that shows card display flow of an end-user-built item.

FIG. 29 shows a chart displaying builder flow used for card creation and minting.

FIG. 30 shows a breakout from the chart in FIG. 29 displaying builder flow.

FIG. 31 shows a breakout from the chart in FIG. 29 displaying builder flow.

FIG. 32 shows a breakout from the chart in FIG. 29 displaying builder flow.

FIG. 33 is a flow chart of a graphical user interface to facilitate social interactions between users for the purpose of NFT creation and users for the purpose of content consumption and viewership.

FIG. 34 is a diagram of certain aspects of the graphical user interface, including as it relates to the social media or social interactive aspects of the platform.

FIG. 35 is a diagram showing further aspects of the graphical user interface, including as it relates to the social media or social interactive aspects of the platform.

### DETAILED DESCRIPTION OF THE INVENTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

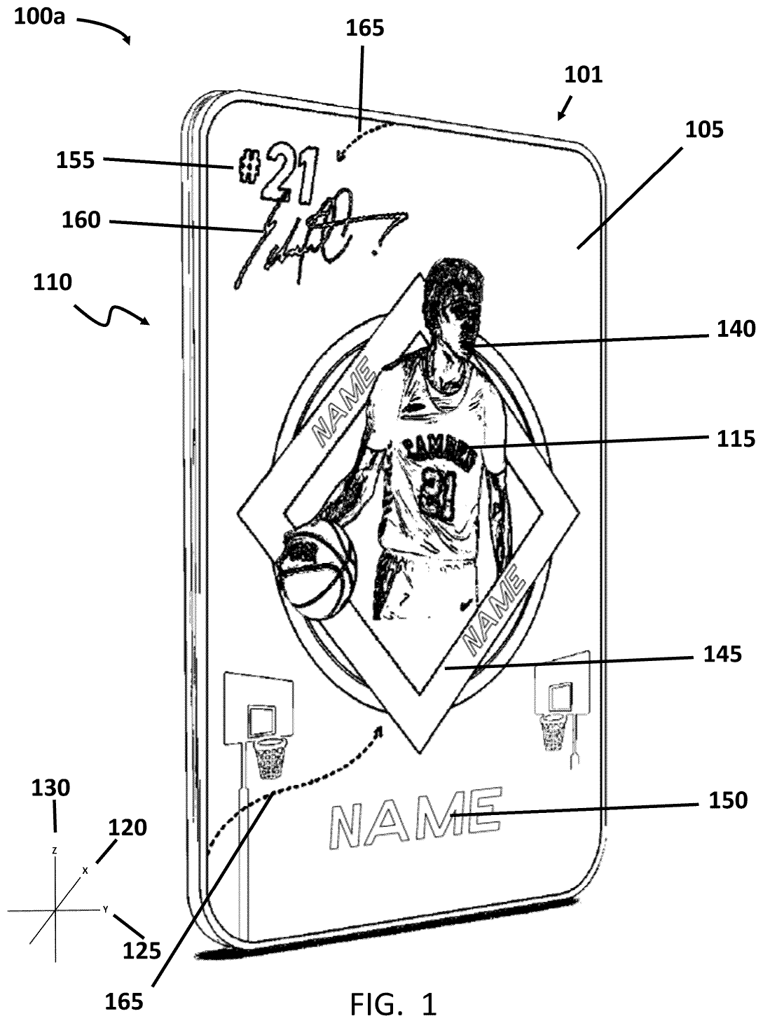

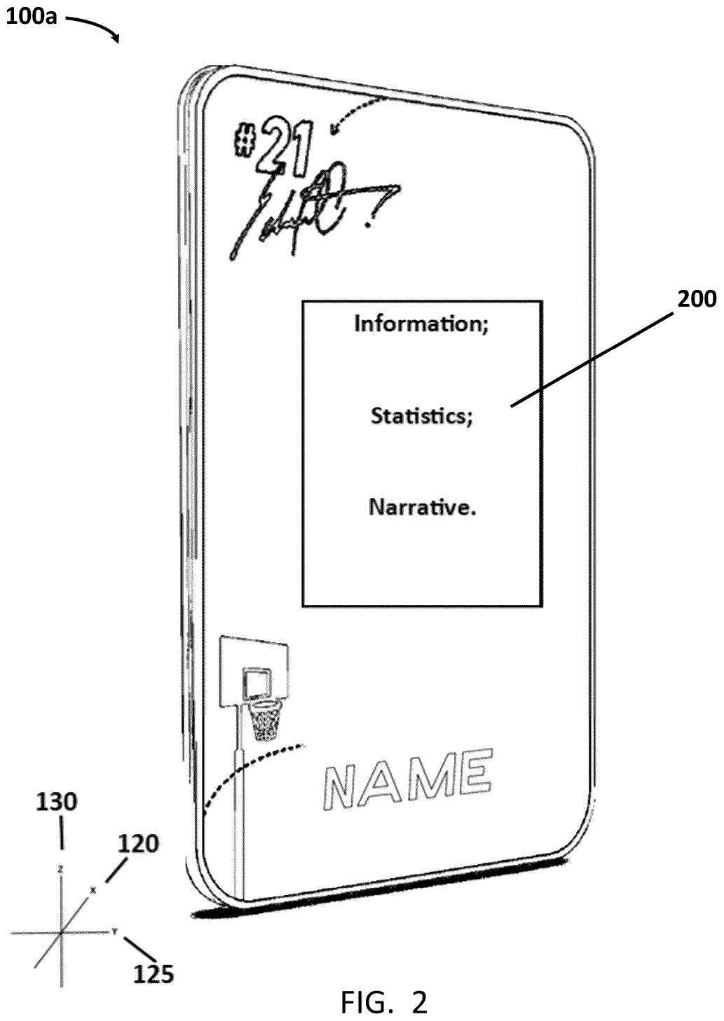

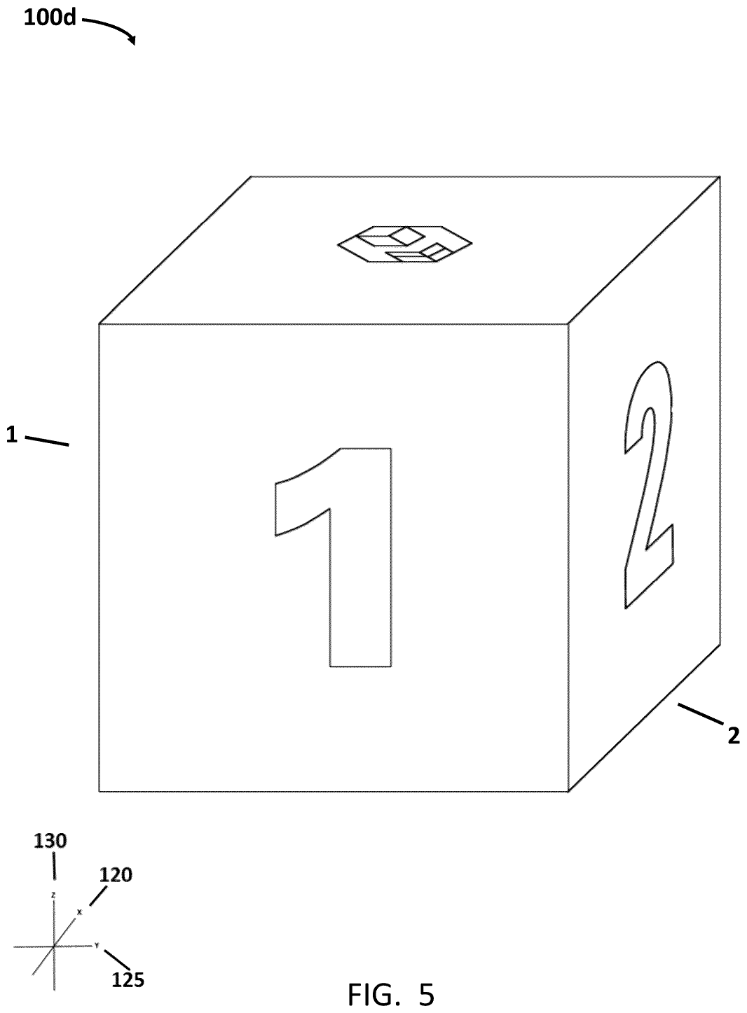

FIG. 1 shows an perspective view of an example of a virtual 3D object 100a. The virtual 3D object 100a is displayed and viewable in a graphical user interface or GUI. Users are enabled to move, control, and manipulate the virtual 3D object 100a in the GUI. In this embodiment, the 100a is a two-sided card shape 101. The virtual 3D object 100a has a first object face 105 and a second object face 110 on its opposite side. The first object face 105 has a multimedia 115. In this particular embodiment, the multimedia 115 is an image of an athlete. In other embodiments, the multimedia 115 is other imagery or information. The multimedia 115 shown in FIG. 2 comprises a non-fungible token or an NFT. The virtual 3D object 100a is rotatable upon an x-axis 120, a y-axis 125, and a z-axis 130. The x-axis 120 is horizontal and parallel to the viewership of the user in the GUI; a y-axis 125 which is vertical and parallel to the GUI; and the z-axis 130 is normal to the GUI, projecting out of the GUI (see FIGS. 1 and 2). The rotation of the virtual 3D object 100a is discussed further beginning at FIG. 5.

The virtual 3D object 100a is displayed by a graphical user interface (GUI). The virtual 3D object 100a is optionally but preferably outfitted with a color scheme and a design. Users are enabled to select characteristics of the NFT, such as color schemes, designs, and layouts using the GUI. The platform may permit users to custom-build their own virtual 3D objects and facilitates outfitting of those virtual 3D objects. The platform may optionally but preferably be used to create an NIL of a virtual 3D object of a primary subject 137.

FIG. 1 has a primary subject image 140. Surrounding the primary subject image 140 is an embedding platform 145. The embedding platform 145 facilitates 3-dimensionality of the primary subject image 140. The embedding platform 145 is a ring in some embodiments and square or diamond in others. As shown in FIG. 1, the embedding platform 145 contains both a ring and a diamond or square. The primary subject image 140 optionally but preferably is truncated and abuts the embedding platform 145, such that an illusion is presented to the viewer in that the primary subject image 140 appears to be protruding from the 145 and/or the virtual 3D object 100a. The virtual 3D object 100a further has an information label 150. In FIG. 1, the information label 150 may be in the bottom-center of the object face 105. The information label 150 includes the name of the subject in FIG. 1, but in other embodiments, the information label 150 includes other information. The virtual 3D object 100a further optionally but preferably includes an information box 155. In FIG. 1, the information box 155 is in the top left-hand corner of the object face 105. In this particular embodiment, the information box 155 contains the jersey number of the primary subject image 140. The object face 105 further contains a signature box 160. The signature box 160 displays the written signature of the primary subject 137. The signature box may include an authentic signature or a replica. FIG. 1 further shows direction points 165. The direction points of FIG. 1 are arrows which direct a viewers'attention to certain information within the virtual 3D object 100a. The aforementioned information can also be included on the second object face 110. The virtual 3D object 100a may be rotated into a first position and then subsequently rotated back into a second position. The user is enabled to orient and re-orient the virtual 3D object 100a to the viewer's preference as to what the viewer would like to view at any particular time. In certain embodiments, the user views the virtual 3D object 100a from a certain angle at a first view, then rotates the virtual 3D object 100a to a second view, and then rotates the virtual 3D object 100a back to the first view.

FIG. 2 is a perspective view of the reverse side of virtual 3D object 100a from FIG. 1. As can be seen in FIG. 2, the reverse side of the virtual 3D object 100a optionally but preferably is outfitted with additional, relevant information in this embodiment. The reverse side of the virtual 3D object 100a has an information window 200. The information window 200 contains additional and sometimes more-detailed information concerning the characteristics of the primary subject image 140. The information window 200 may include information for further resources. The information window 200 may also contain information on where to find additional information, such as hyperlinks.

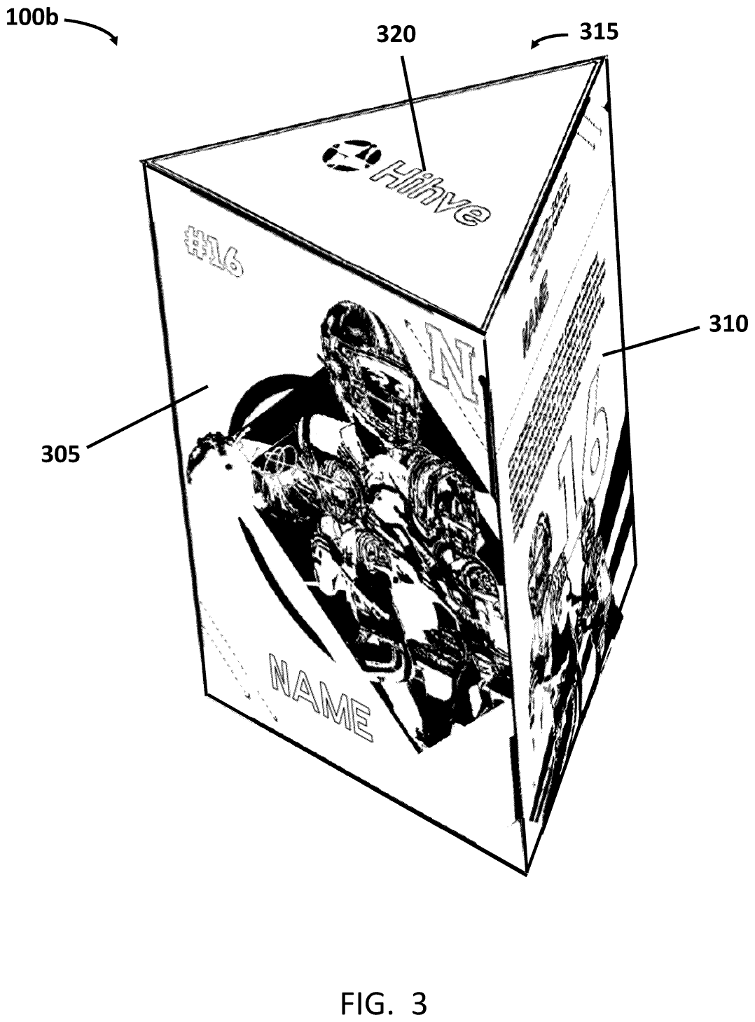

FIG. 3 is a perspective view of a virtual 3D object 100b. The virtual 3D object 100b is a prism shape, which has five total sides with three sides being display sides or interactive sides. The user optionally but preferably is enabled to see three display sides when using the platform. The virtual 3D object 100b has a first prism face 305, a second prism face 310, and a third prism face 315. As is visible in FIG. 3, the virtual 3D object 100b has a triangular surface 320 at the poles of the virtual 3D object 100b. Further, the user is enabled to rotate the virtual 3D object 100b. The GUI displays the virtual 3D object 100b such that more than one face is visible, which prompts the user to know that there is more than one face. The user rotates the virtual 3D object 100b from a first position into a second position. After a requisite amount of time, the virtual 3D object 100b rotates back into the first position. The user may also rotate the virtual 3D object 100b into a third position.

At some intervals of rotation in the virtual 3D object 100b depicted as the prism shape in FIG. 3, just the first prism face 305 is visible. At other intervals, the first prism face 305 and the second prism face 310 are visible, with the first prism face 305 being more visible than the second prism face 310 and the second prism face 310 being viewed from a more-narrow angle. At some intervals, the user is able to only see the second prism face 310 with the first prism face 305 and the third prism face 315 not being visible. At other intervals, the user is able to see the second prism face 310 and the third prism face 315, but not the first prism face 305. At some intervals, the user is able to see the third prism face 315, with the first prism face 305 and the second prism face 310 not being visible. At still other intervals, the user is able to see the third prism face and the first prism face 305, with the first prism face 305 being at a sharper or more-narrow angle than the third prism face 315. The user is able to rotate the virtual 3D object 100b for all permutations mentioned herein, and is able to rotate the virtual 3D object 100b back. Optionally, object 100b may be rotated on X-axis and/or Y-axis to show the top and/or bottom faces of the prism, with optionally but preferably image(s) thereon.

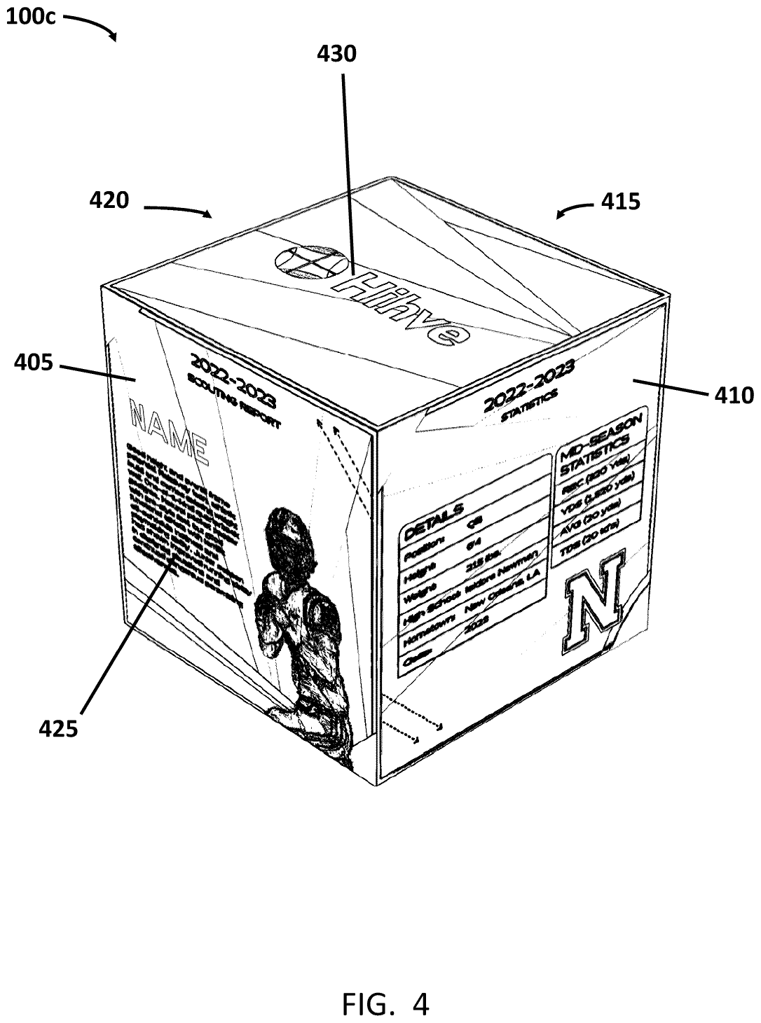

FIG. 4 shows a perspective view of a virtual 3D object 100c, which is a rectangular shape object in this particular embodiment. Optionally, the rectangular shape may be a cube shape. In this embodiment, the virtual 3D object 100c is a cube figure, which includes has six total sides with four sides being interactive sides or display sides. The virtual 3D object 100c has a first cube face 405. In the first cube face 405, the primary subject optionally but preferably is displayed. Also visible in FIG. 4 is a second cube face 410. In FIG. 4, the viewer can see the first cube face 405 and the second cube face 410, with the second cube face being at a sharper angle from the perspective of the viewer.

As the user rotates the virtual 3D object 100c clockwise, the second cube face 410 is rotated into a more-direct view. As the user continues to rotate the virtual 3D object 100c clockwise, a third cube face 415 comes into view. If the user continues to rotate the virtual 3D object 100c clockwise, a fourth cube face 420 comes into view. However, if the user begins at a view of the first cube face 405 in the forward position, and then rotates the virtual 3D object 100c counter-clockwise, the fourth cube face 420 will next come into view.

The four primary faces in FIG. 4 are optionally but preferably populated with different media in this particular embodiment. The primary subject is prominently displayed on the first cube face 405. In this embodiment, the first cube face also contains a narrative section 425 that is displayed adjacent to the primary subject. In this embodiment, the viewer is enabled to look at the primary subject next to the narrative section 425, which provides information crafted and selected by the creator of the virtual 3D object or user of the platform. A configuration that shows a narrative section 425 next to a primary subject on the first cube face 405 allows NFT creators to put their best and most compelling information next to the subject, such that it is most likely to be viewed by the viewer and for the viewer to associate such information with the primary subject. The cube shape of virtual 3D object 100c also has a pole-face 430. In the embodiment displayed in FIG. 4, the pole-face shows the logo of the platform.

Optionally one or more of the faces of the objects, such as virtual 3D object 100c, may be transparent, translucent, or non-existent thereby giving viewable access to the interior of virtual 3D object 100c. Such interior may include one or more other objects and/or images. Also, such viewable access optionally but preferably shows faces on the interior of the object, with such interior faces optionally but preferably having one or more images thereon.

FIG. 5 shows a perspective view of a virtual 3D object 100d. FIG. 5 is a rectangular shape, such as optionally a cube object, having a cube face 1 visible to the viewer. Also seen in FIG. 5, the virtual 3D object 100d has a cube face 2 which is also visible. As seen in FIG. 5, the top-side view of the virtual 3D object 100d may have a logo, in this case the logo of the platform, on its face. In other angles as the virtual 3D object 100d is rotated, cube face 1 is visible to the viewer and no other cube faces are directly visible to the viewer.

In FIG. 5, the angles of the cube face 1 and the cube face 2 are two separate angles to the viewer. Having two separate angles of viewership for cube face 1 and cube face 2 assists in causing the cube to form a realistic perspective to the viewer. As the virtual 3D object 100d is rotated, the angle of viewership of the cube faces optionally but preferably may be altered to coincide with the angle of viewership. The angle of the images optionally but preferably are altered such as to coincide with the angle of viewership and to maintain a sense of realistic object movement and orientation. In a linear X-axis rotation, the cube face 1 will continue to move toward a sharper angle as cube face 2 continues to move toward a flatter angle in relation to the viewer. The viewer or end-user is enabled to maintain control of the orientation and to manipulate the orientation of the virtual 3D object 100d. For instance, the end-user may rotate the virtual 3D object 100 about the X-axis, the Y-axis, and/or the Z-axis. The virtual 3D object 100d may be programmed such that there is a default orientation.

Additionally, the virtual 3D object 100d may exhibit a certain degree of inertia as it is rotated. For instance, if a viewer rotates the virtual 3D object 100d and then ceases to rotate, the virtual 3D object 100d may continue to move that direction for a short period of time before coming to a rest. Or, optionally but preferably it may spin with little virtual friction for a longer period of time (2-3 seconds) and/or until the user intervenes to stop the spinning.

In some embodiments, the default orientation is the orientation shown in FIGS. 5 and 4. In some embodiments, the virtual 3D object will be programmed to automatically shift orientation back to the default orientation. For instance, if an end-user rotates the virtual 3D object 100d in a position different than that shown in FIG. 5 and then ceases control or ceases movement of the virtual 3D object the GUI will automatically cause the virtual 3D object 100d to rotate back to the default orientation. In some embodiments, the virtual 3D object 100d will re-orient itself after approximately 5 minutes. In other embodiments, the virtual 3D object 100d will re-orient itself after approximately 2 minutes. In other embodiments, the virtual 3D object 100d will re-orient itself after approximately 30 seconds. In some embodiments, the virtual 3D object 100d will re-orient itself after approximately 10 seconds. In some embodiments, the virtual 3D object 100d will re-orient itself after approximately 5 seconds. In some embodiments, the virtual 3D object 100d will re-orient itself after approximately 1-3 seconds.

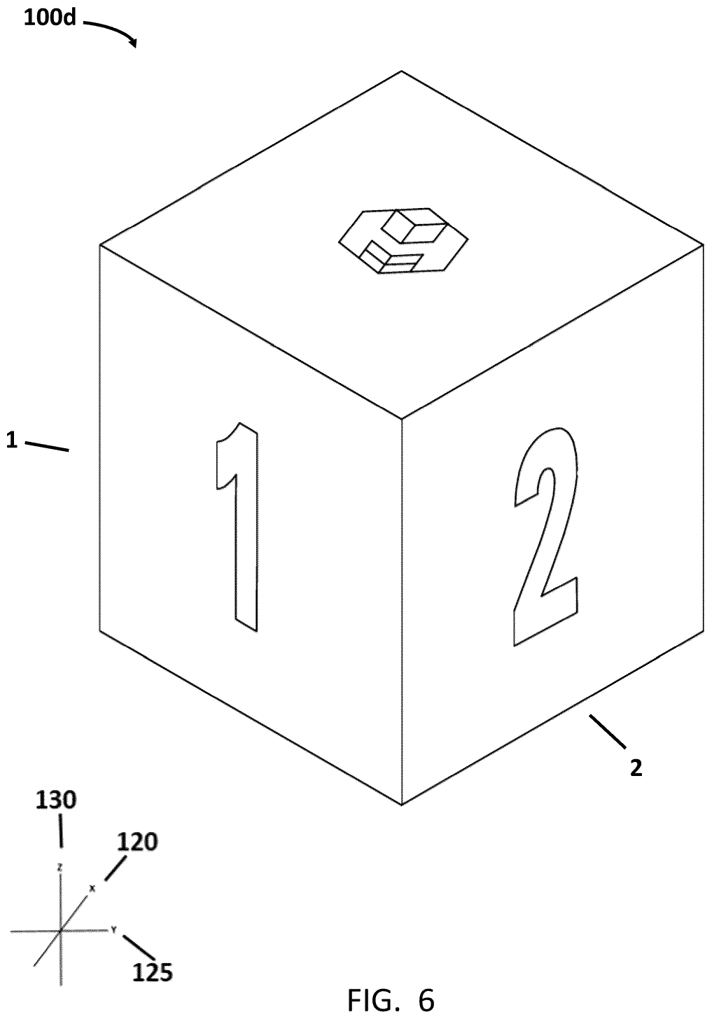

As the virtual 3D object 100d is rotated clockwise from right to left, such as toward the orientation in FIG. 6, the viewing angles of cube faces shift to coincide with the end-user's viewing angle of the virtual 3D object 100d. As the virtual 3D object 100d is rotated from the orientation shown in FIG. 5 to the orientation shown in FIG. 6, the cube face 1 and cube face 2 are shifted to coincide with the viewing angle of the virtual 3D object 100d. In FIG. 2, the angles of view of cube face 1 and cube face 2 are congruent but at opposite angles to the viewership. In the embodiment depicted in FIG. 6, the logo on the top side of the virtual 3D object 100d rotates along with cube face 1 and cube face 2, in other embodiments, the logo on the top side of the virtual 3D object 100d maintains a constant orientation toward the viewer. The virtual 3D object 100d may be rotated back into the position shown in FIG. 5. In other angles as the virtual 3D object 100d is rotated, cube face 2 is visible to the viewer and no other cube faces are directly visible to the viewer.

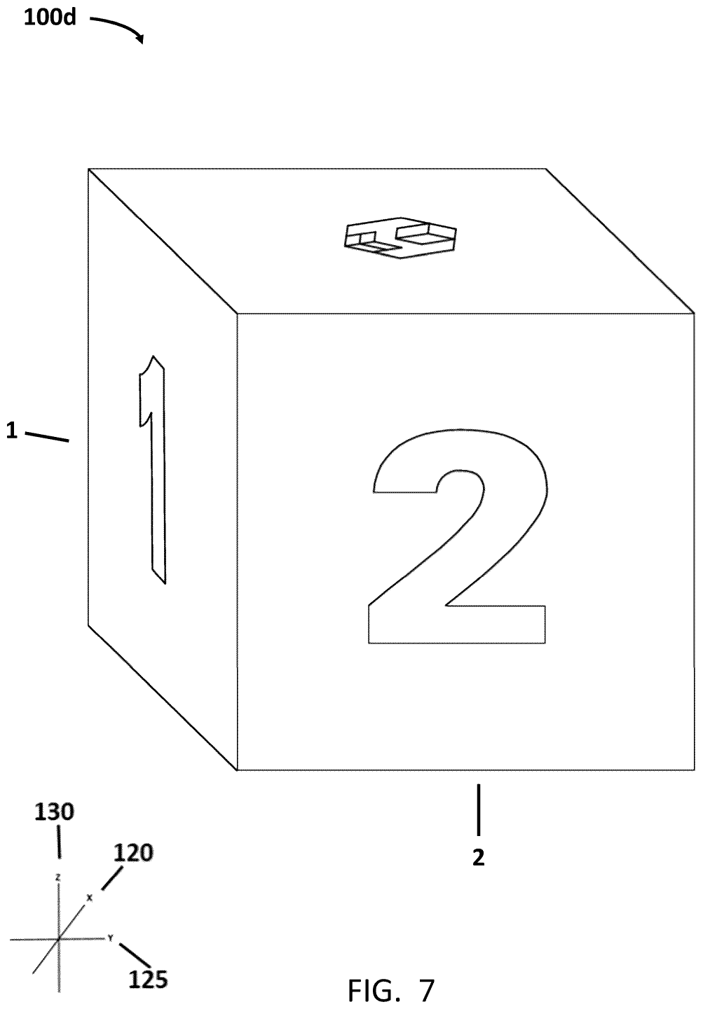

FIG. 7 shows the virtual 3D object 100d optionally but preferably as it continues to rotate clockwise from right to left. As depicted in FIG. 7, cube face 1 must rotate in relation to cube face 2 such that cube face 2 is more flattened towards the view of the end-user and cube face 1 is more angled away from the viewer as compared to FIGS. 5 and 6.

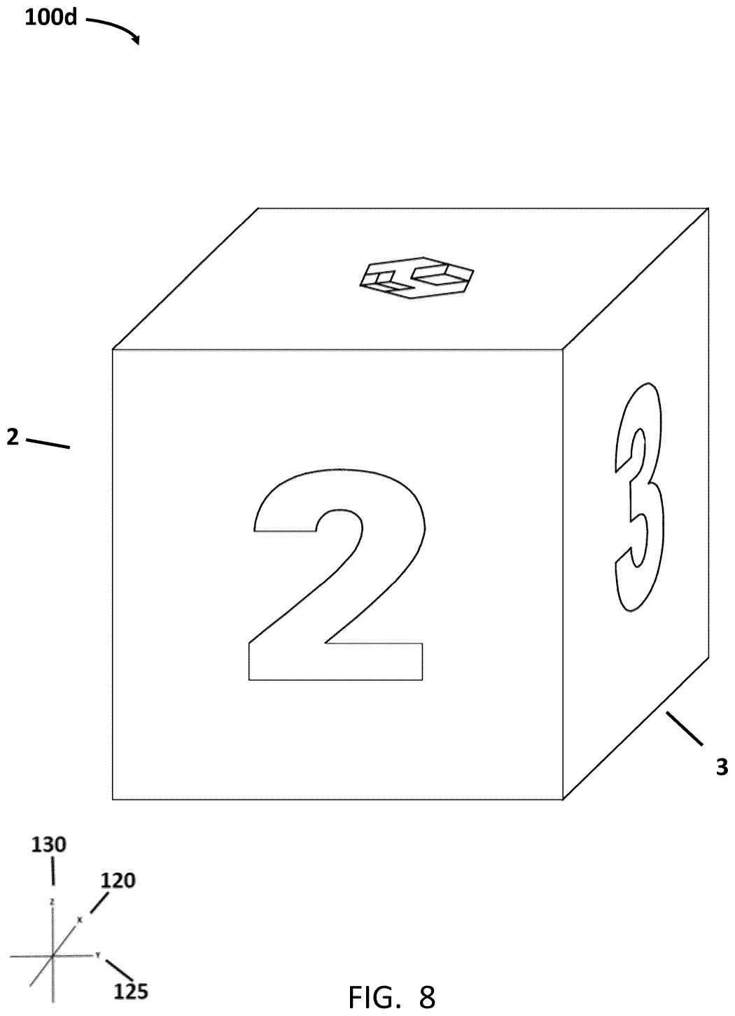

FIG. 8 depicts the virtual 3D object 100d as it continues to rotate clockwise from right to left. As the virtual 3D object 100d continues to rotate, cube face 1 is rotated out of view. Cube face 2 of virtual 3D object 100d rotates cube face 2 into a position that is more flattened to the viewer. As the virtual 3D object 100d rotates from right to left, cube face 3 is rotated into view. In FIG. 8, cube face 3 is more angled in relation to the viewer whereas cube face 2 is at an angle more flattened to the viewer. Thus, cube face 2 optionally but preferably appears more clearly or directly oriented in the view of the end-user whereas cube face 2 is at a sharper angle. In other angles as the virtual 3D object 100d is rotated, cube face 3 is visible to the viewer and no other cube faces are directly visible to the viewer. Such is true of the other cube faces as the virtual 3D object 100d rotates.

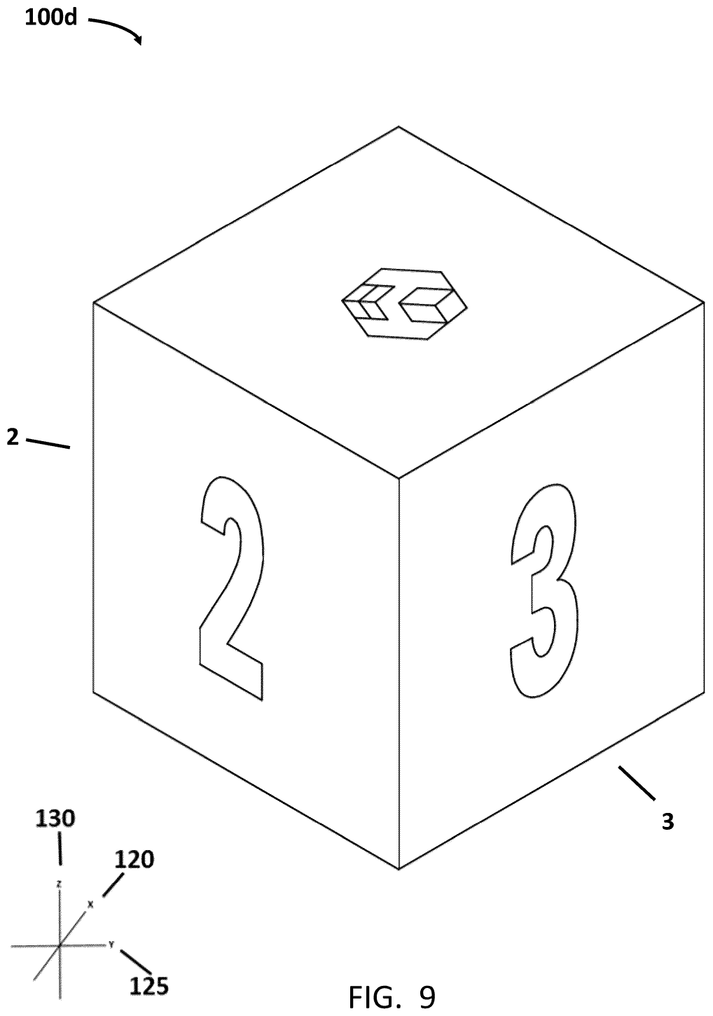

FIG. 9 shows the virtual 3D object 100d as it continues to rotate clockwise from right to left. In FIG. 9, cube face 2 and cube face 3 are visible to the viewer at equal but opposite angles. The viewer is able to see the images on cube face 2 and cube face 3 with equal angles.

Both cube face 2 and cube face 3 show images at more acute angles than when either cube face 2 and cube face 3 are flattened to the viewer. From the angle shown in FIG. 9, the viewer may rotate the virtual 3D object 100d clockwise or counterclockwise to draw either cube face 2 or cube face 3, respectively, into a flatter, more direct view.

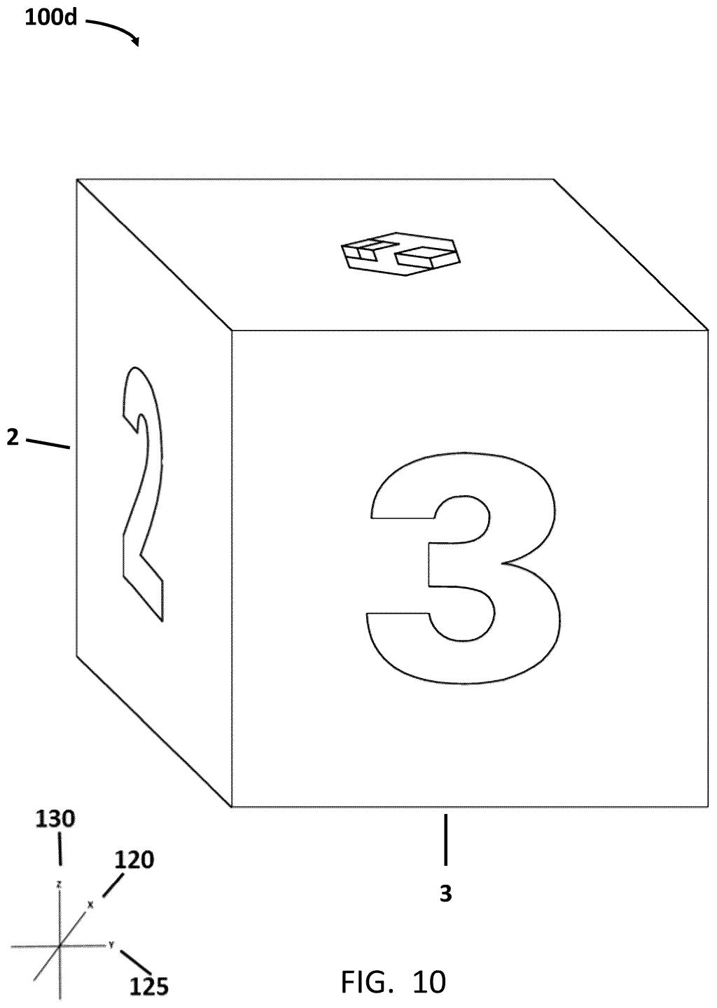

FIG. 10 shows cube face 3 at a more flattened or direct angle to the viewer compared to FIGS. 8 and 9. Cube face 2 is at a sharper or more acute angle in comparison to FIG. 8 or 9.

As the virtual 3D object 100d continues to rotate clockwise from right to left, the cube face 3 will continue to rotate into a flatter angle toward a more direct view to the viewer as compared to FIGS. 8 and 9.

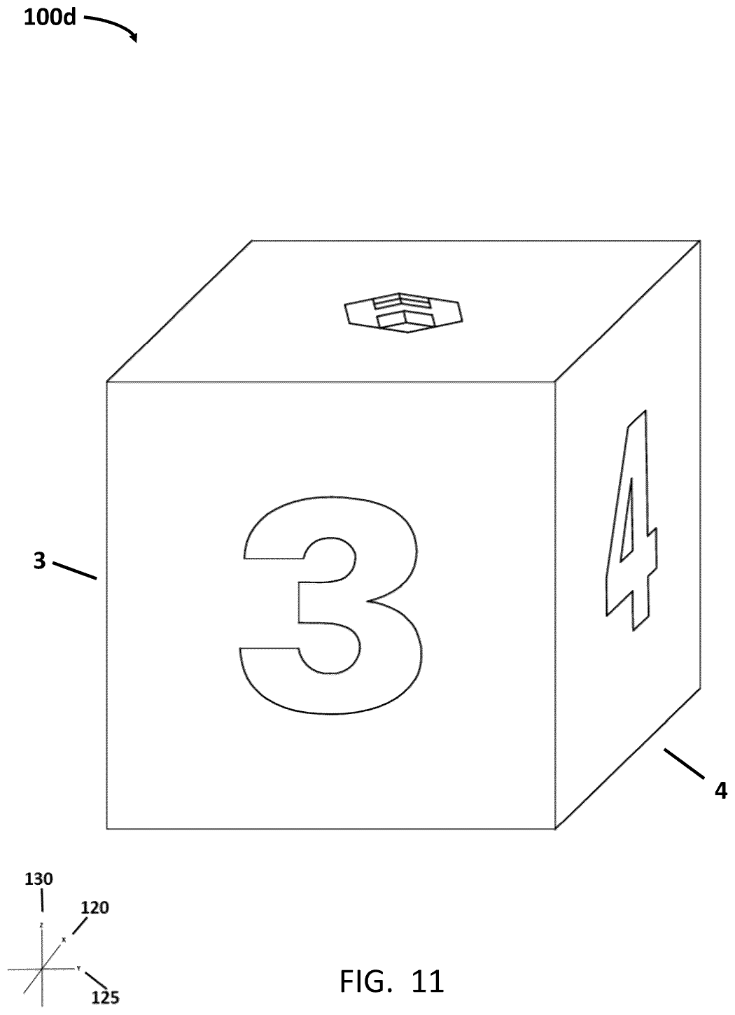

FIG. 11 shows the virtual 3D object 100d as it continues to rotate clockwise or right to left as compared to FIG. 10. The cube face 3 has a flattened view still, and the virtual 3D object 100d has been rotated to reveal a cube face 4. The cube face 4 is at a sharper or more acute angle than cube face 3, in FIG. 11.

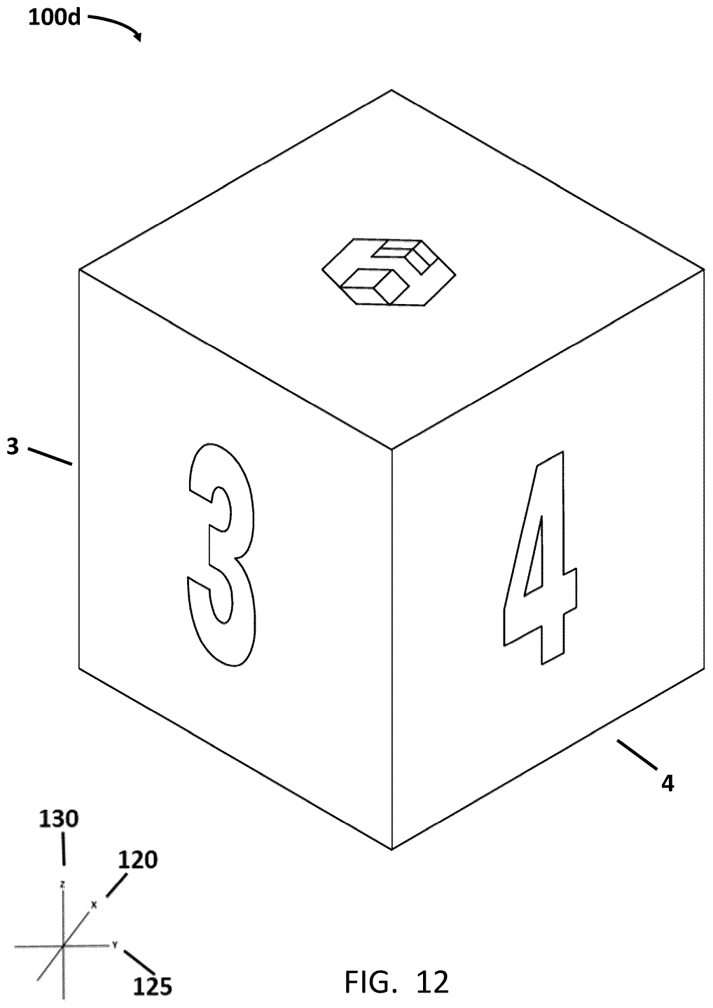

FIG. 12 shows the virtual 3D object 100d as it continues to rotate clockwise or right to left as compared to FIG. 11. In FIG. 12, cube face 3 and cube face 4 are at equal and opposite angles to one another from the perspective of the end-user or viewer.

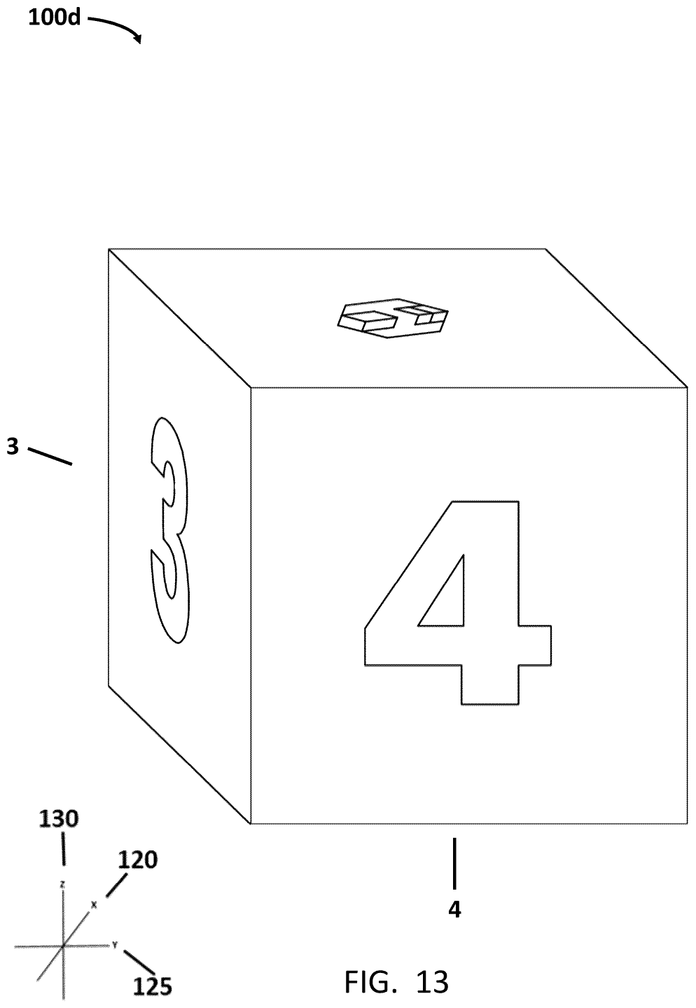

FIG. 13 shows the virtual 3D object 100d as it continues to rotate clockwise or right to left as compared to FIG. 12. In FIG. 13, cube face 3 is at a more acute or sharper angle from the perspective of the end-user or the viewer. The cube face 3 sits to the left of cube face 4.

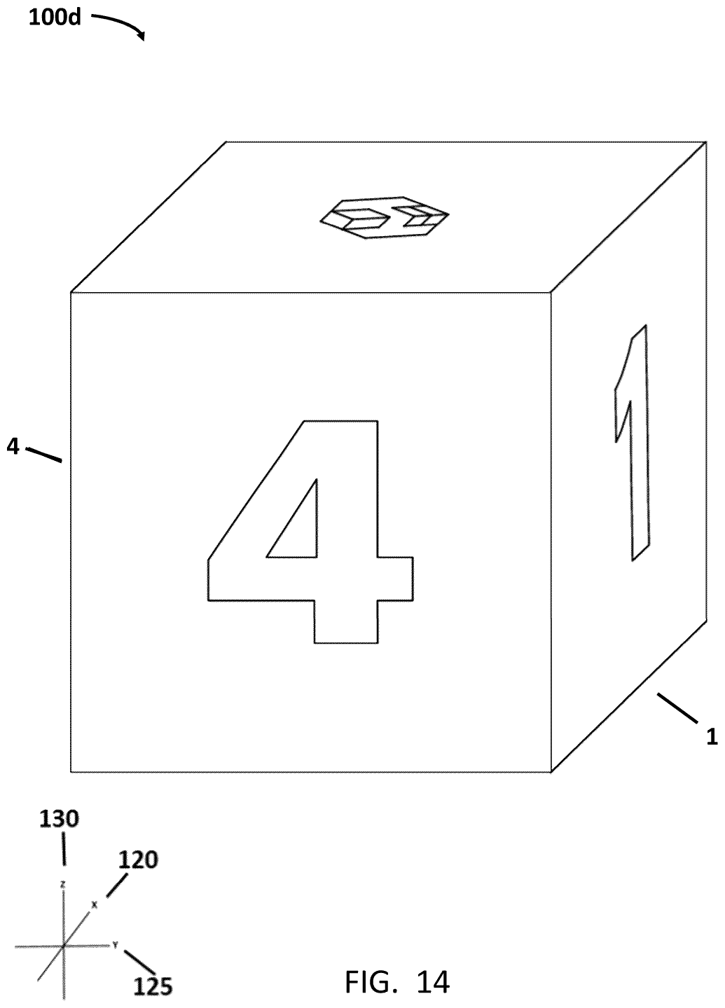

FIG. 14 shows the virtual 3D object 100d as it continues to rotate clockwise or right to left as compared to FIG. 13. In the orientation depicted in FIG. 14, the cube face 4 is to the left of cube face 1. Cube face 4 is at a flatter or more direct view to the end-user compared to cube face 1. Cube face 1 is at a sharper or more narrow view to the end-user.

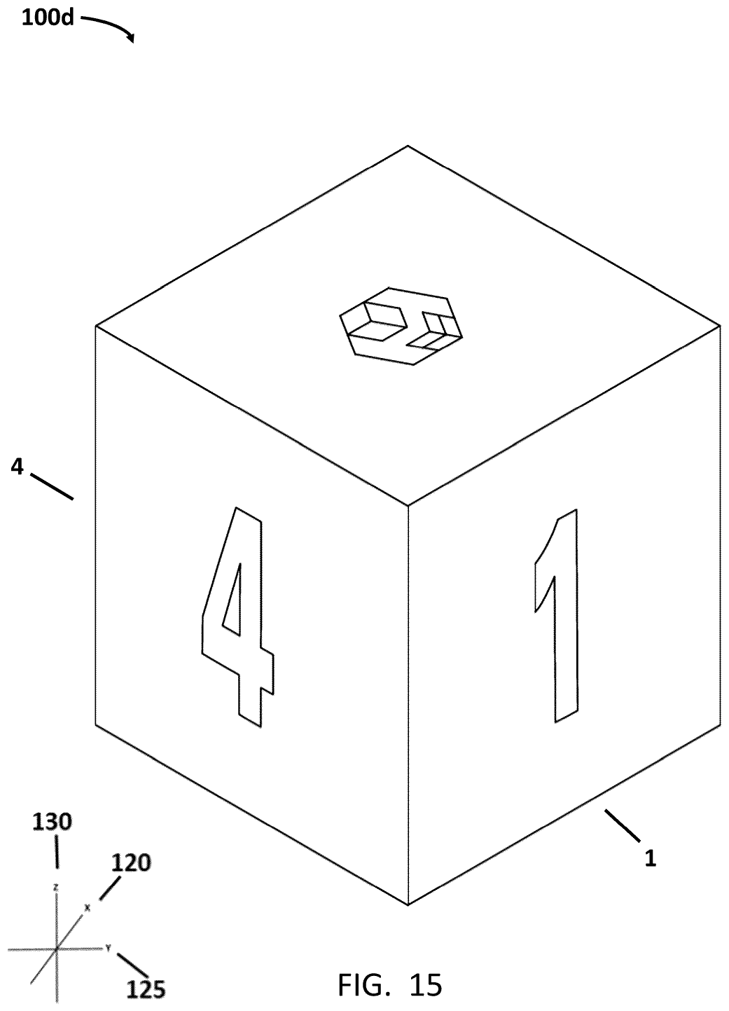

FIG. 15 shows the virtual 3D object 100d as it continues to rotate clockwise or right to left as compared to FIG. 14. In the orientation shown in FIG. 15, the cube face 4 and the cube face 1 are at equal and opposite angles from one another in relation to the end-user or viewer.

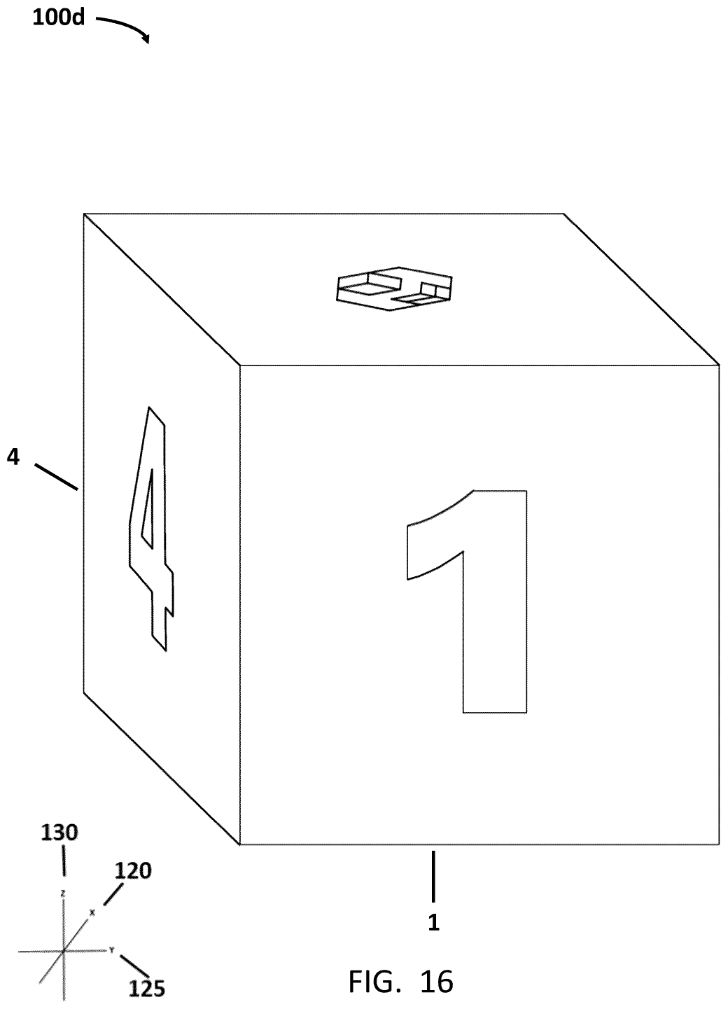

FIG. 16 shows the virtual 3D object 100d as it continues to rotate clockwise or right to left as compared to FIG. 15. In the orientation shown in FIG. 16, cube face 4 is seen to the left of cube face 1. Cube face 4 is at a sharper or more acute angle in the perspective of the viewer as compared to cube face 1.

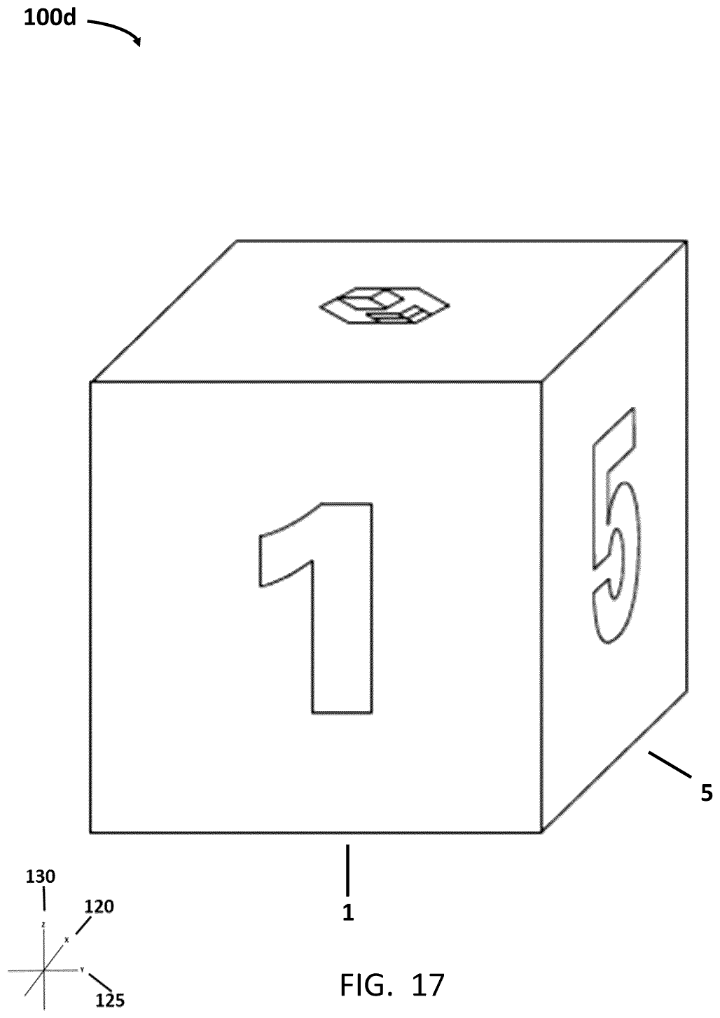

FIG. 17 shows a perspective view of the virtual object 100d according to a particular embodiment. However, as the virtual object 100d is rotated from the orientation shown in FIG. 16, and then rotated back to the view shown in FIG. 17, a new cube face 5 appears in the place of cube face 2. For example, if a viewer began with the orientation shown in FIG. 5, and then rotated counter clockwise from left to right in the view shown in FIG. 16, and then rotated back clockwise from right to left to the view shown in FIG. 17 (corresponding to the view previously shown in FIG. 5), the viewer will now see a different cube face (namely cube face 5), in place of cube face 2. The new cube face, cube face 5, has different media or imagery than the previous cube face 2 that is now visible to the viewer. In this regard, the virtual object 100d can take on an amorphous, ever-changing nature to provide the viewer with fresh content and entertainment.

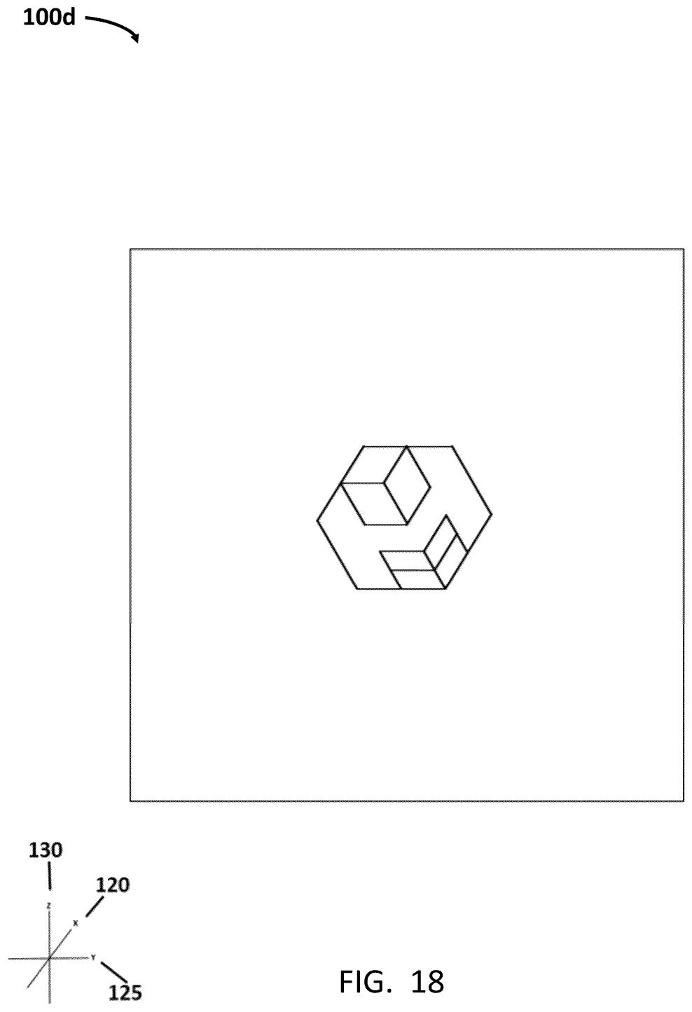

FIG. 18 shows a top-down view of the virtual 3D object 100d according to a particular embodiment. In the view depicted in FIG. 18, the end-user can see the face of the virtual 3D object 100d which shows the platform logo. In FIG. 18, according to this embodiment, no other cube face is visible.

As the virtual 3D object 100d rotates, the virtual 3D object 100d may be seen at the orientations shown in FIGS. 5-18 but also appears at each or most angles there between as the virtual 3D object 100d is rotated by the user. Similarly, if the virtual 3D object 100d is moved back in the opposite direction, each angle there between will be visible along its rotation. Furthermore, if the object re-orients itself back to a default orientation, each angle there between is visible along the rotation. The object, when re-oriented back to default, optionally may remain the same as the face once seen at the beginning.

The movements and rotations of object 100d shown and described in connection with FIGS. 5-18 optionally but preferably may be used with each and all of the other objects described, including but without limitation objects 100a, 100b, 100c, and 100e.

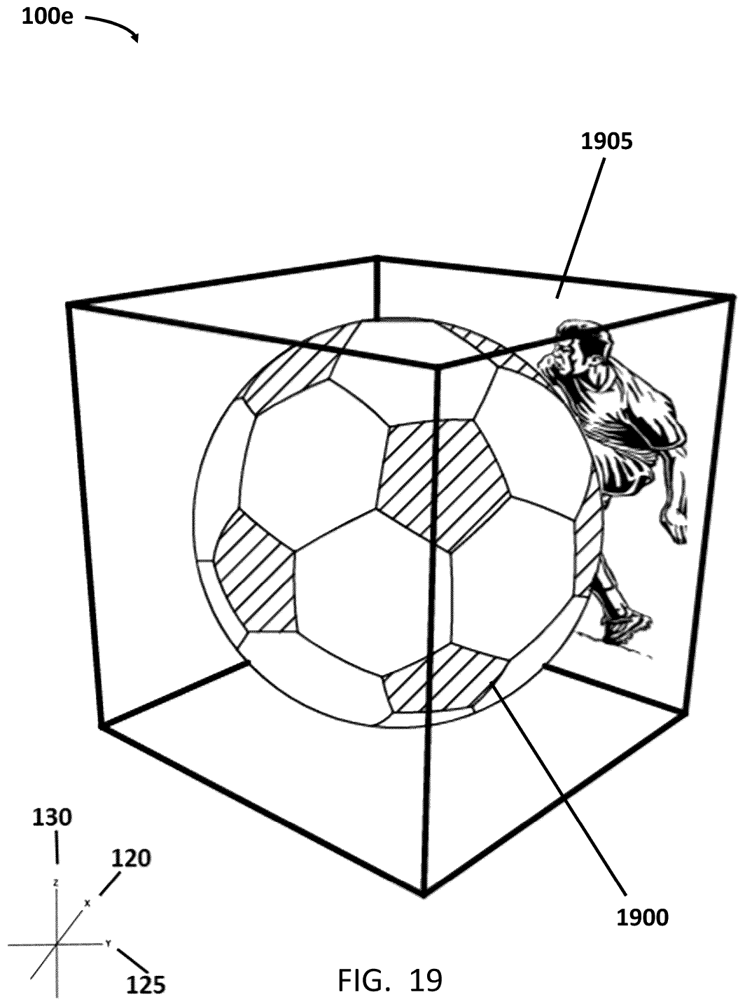

FIG. 19 shows a different embodiment of the 3D virtual object, 3D virtual object 100e. In FIG. 19, the primary imagery 1900 is inside the cube shape of the 3D virtual object 100e. Similarly, in this embodiment, the image on the inside surface 1905 of the cube shape of the 3D virtual object 100e contains media. As the viewer looks at and rotates the 3D virtual object 100e, the image on the inside surface 1905 is visible. In some embodiments, the other surfaces on the inside of the 3D virtual object 100e show media. In other embodiments, a combination of the inside surface and the outside surface are used to show media. Additionally, regarding the inside surface and the outside surface, a number of different media images can be used and change as the 3D virtual object 100e is rotated.

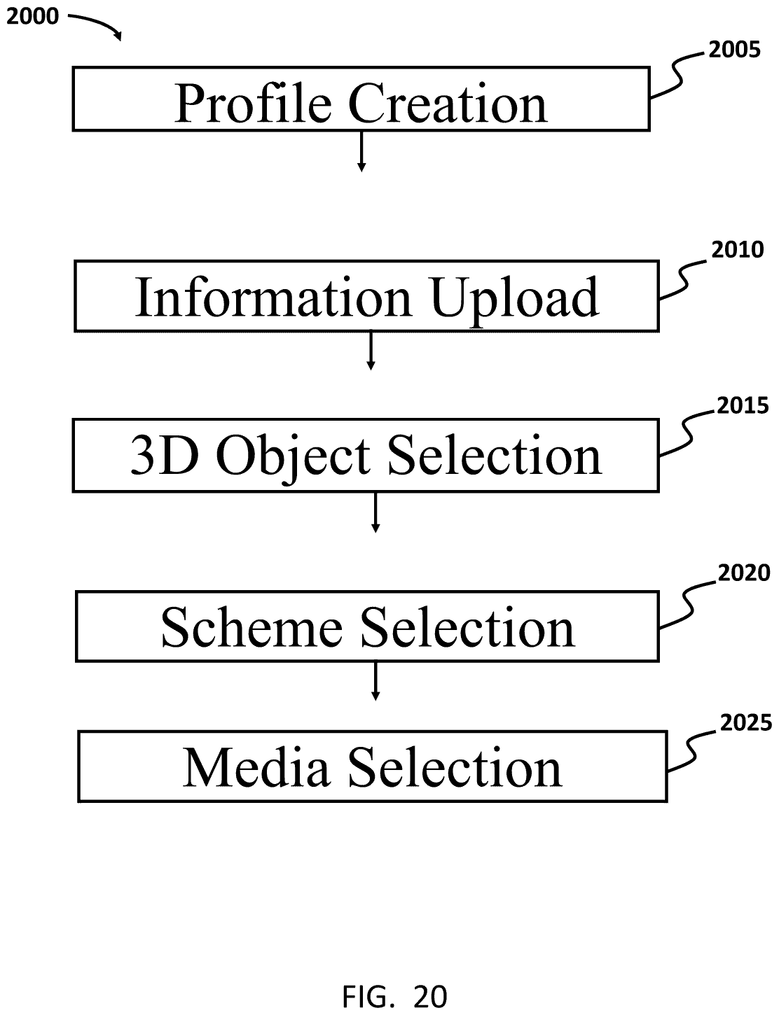

FIG. 20 shows a flowchart 2000 of the system to optionally but preferably facilitate creation of NFTs and virtual 3D objects by a user. In this embodiment, the flowchart begins with profile creation 2005. The user creates a profile within the graphical user interface in order to track activity associated with the user. The flowchart next moves to information upload 2010. This step, combined with the profile creation 2005, groups and tracks data uploaded by and associated with that user. The data optionally but preferably includes the upload of media; NIL management and creation; the creation of NFTs; blockchain data; and virtual 3D object creation. The flowchart next includes virtual 3D object selection 2015, in which the user selects which type of virtual 3D object the user intends to render. The user then optionally but preferably moves to scheme selection 2020, in which the user selects a scheme for use in creating the virtual 3D object. The scheme selection 2020 includes format, color, and certain other media combinations. Related to the virtual 3D object selection 2015, the user optionally but preferably moves to media selection 2025, in which the user selects certain media for use in the creation of the NFT or virtual 3D object. The user is enabled to begin grouping information for display on a virtual 3D object.

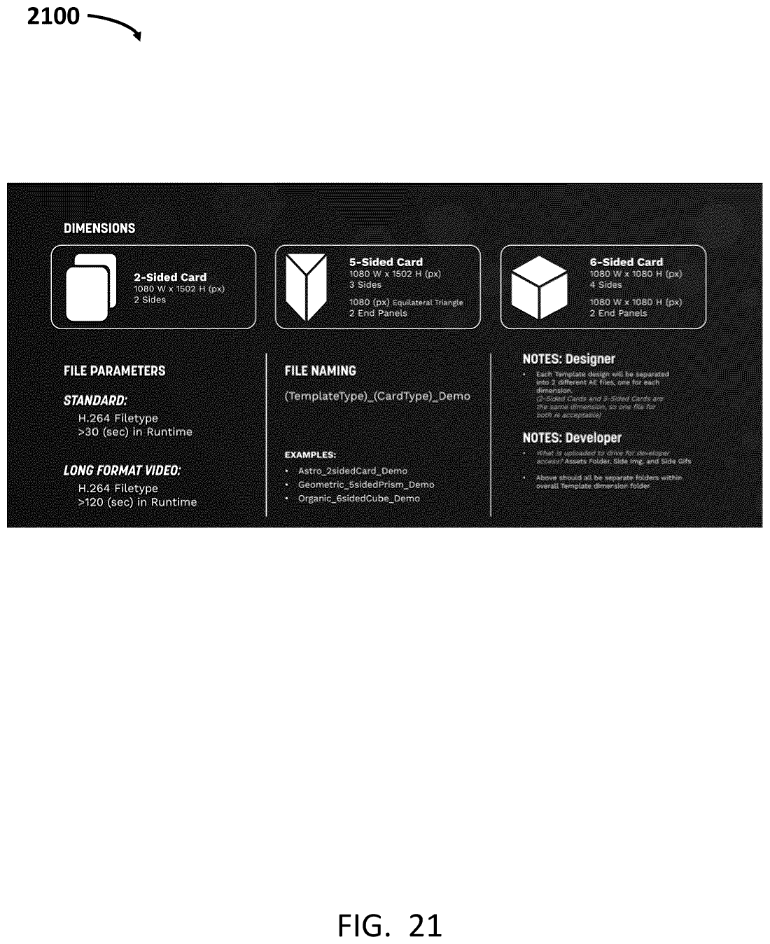

FIG. 21 shows an optional embodiment of a template selection screen 2100 within the graphical user interface. Users are enabled to select a card type to begin populating media. The object builder or card builder differentiates between file types. One feature of this embodiment, is the virtual 3D objects often have overlapping file-type dimensions. For instance, the two-sided card and the five-sided card have similar or identical dimensions such that an image or media uploaded for the purpose of a two-sided card may be used during the creation of a five-sided card. The graphical user interface separates the card-types into separate user folders within an overall template dimension folder to facilitate virtual 3D object creation.

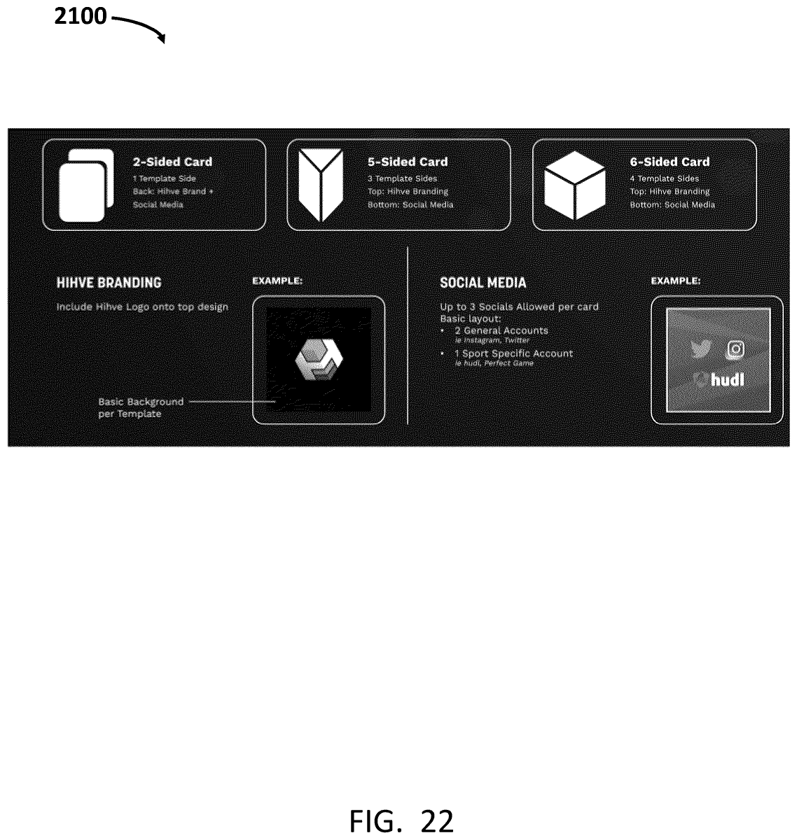

FIG. 22 shows further characteristics of an optional but preferable embodiment of the card-building feature. In a basic layout, the user is enabled to upload information pertaining to other media-types and platforms, such as social media pages like Twitter (now known as X) and Instagram or Facebook. The virtual 3D object may also contain other sports-specific media accounts such as Hudl. The graphical user interface allows users to display real-time media on the virtual 3D object, including photographs, GIFs, and video. Such real-time media optionally but preferably will display or play while the user is viewing the virtual 3D object, including when on the platform. Additionally, in some embodiments, the virtual 3D object includes hyperlinks to direct viewers to other content, such as highlight videos.

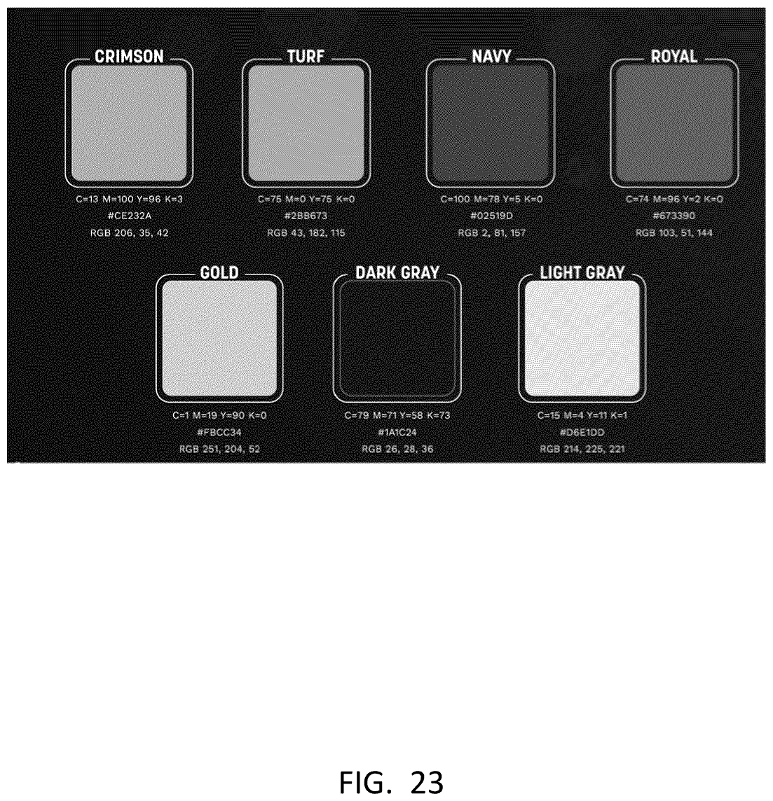

FIG. 23 displays a page within the graphical user interface that allows users to select a color scheme or package of colors to optionally but preferably be used in virtual 3D object creation.

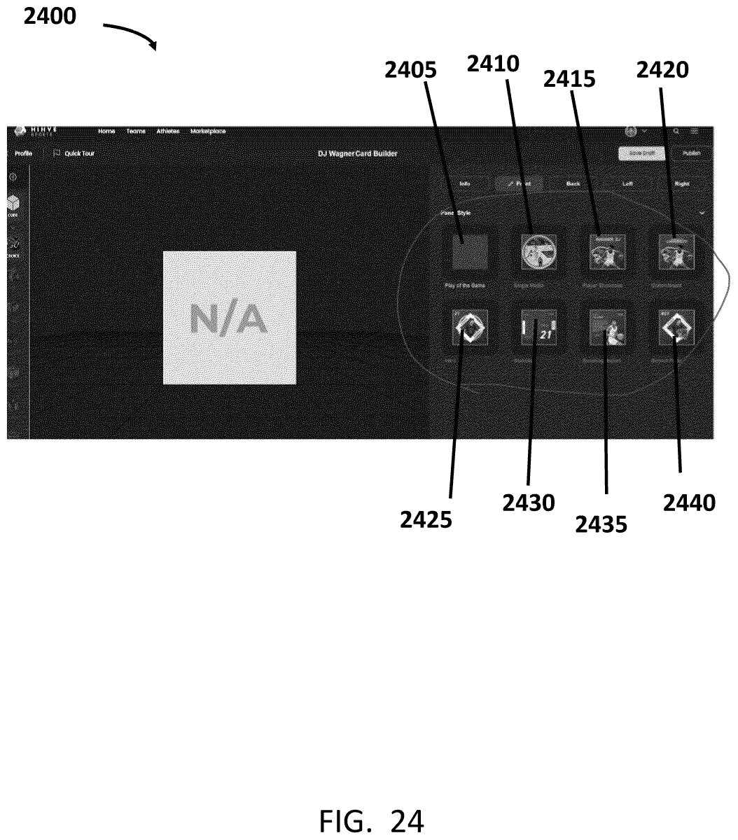

FIG. 24 is another window within the graphical user interface which facilitates creation of certain media to be displayed on the virtual 3D object such as virtual 3D objects 100a, 100b, 100c, 100d, and 100e. This particular page optionally but preferably allows users to select and affix media types from the GUI at screen 2400 onto the virtual 3D object 100a-e, including a play of the game 2405; a single media 2410; a player showcase 2415; a commitment 2220 (such as committing to a particular school); an intro 2425; statistics 2430; a scouting report 2235; and school pride 2440.

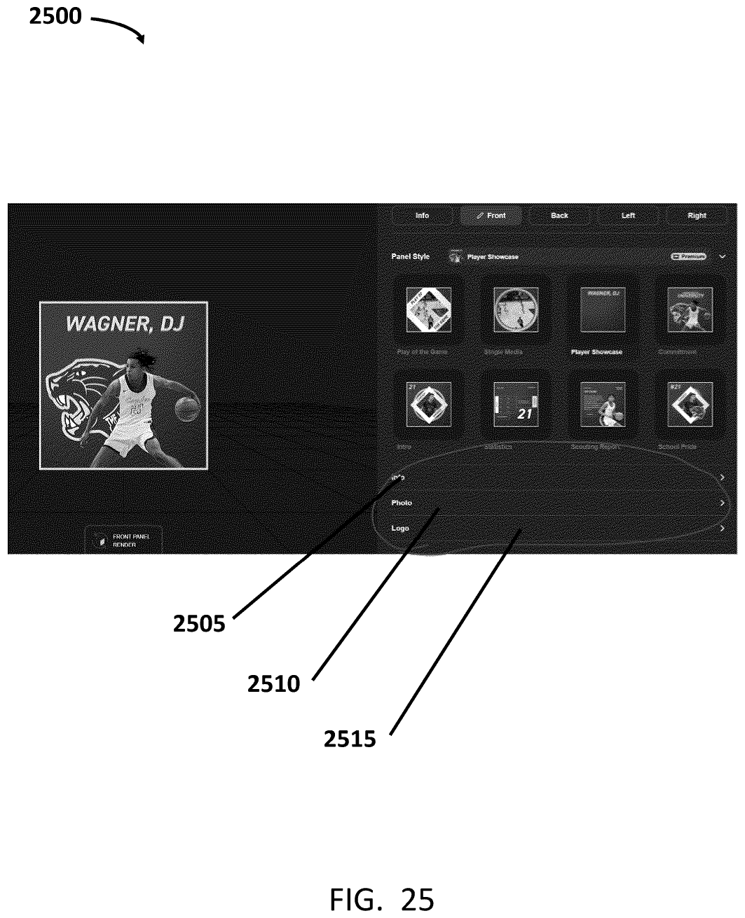

FIG. 25 shows another optional page within the graphical user interface of the platform. Once a user selects a media-type, such as player showcase, the user will be given a menu screen 2500 with further features and characteristics. In the embodiment displayed in FIG. 25, the user is permitted to select and add to an “Intro” 2505; a Photo”2510; and a “Logo” 2515.

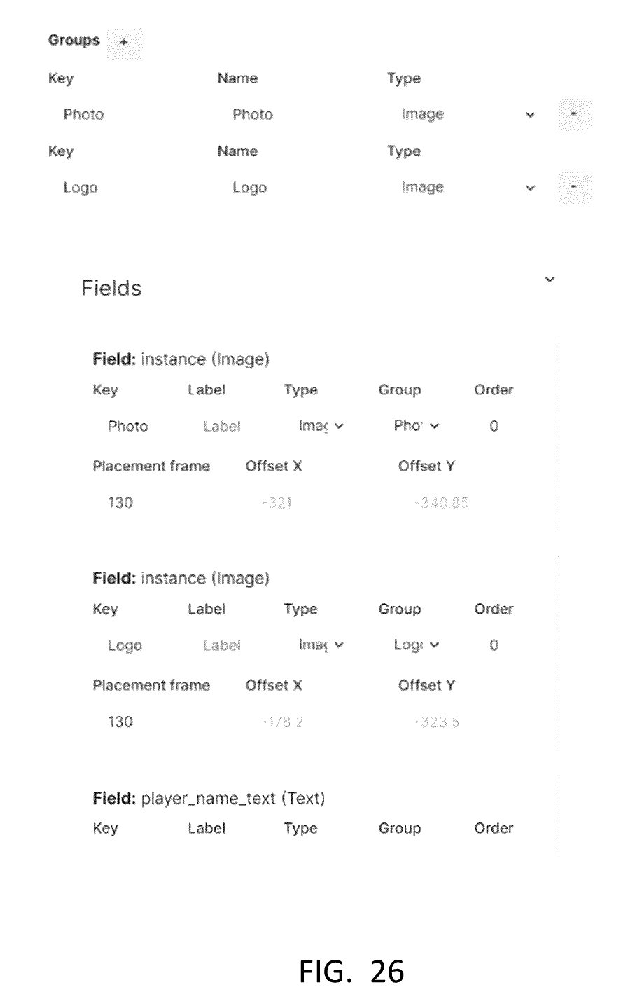

FIG. 26 shows another optional portion of the graphical user interface of the platform. FIG. 26 shows another facet in which the graphical user interface facilitates the creation of unique NILs on virtual 3D objects. The user is prompted to modify media, such as images, including by specifying labels, types, groups, orders, placement of frames, offsetting of X-axis, and offsetting of Y-axis.

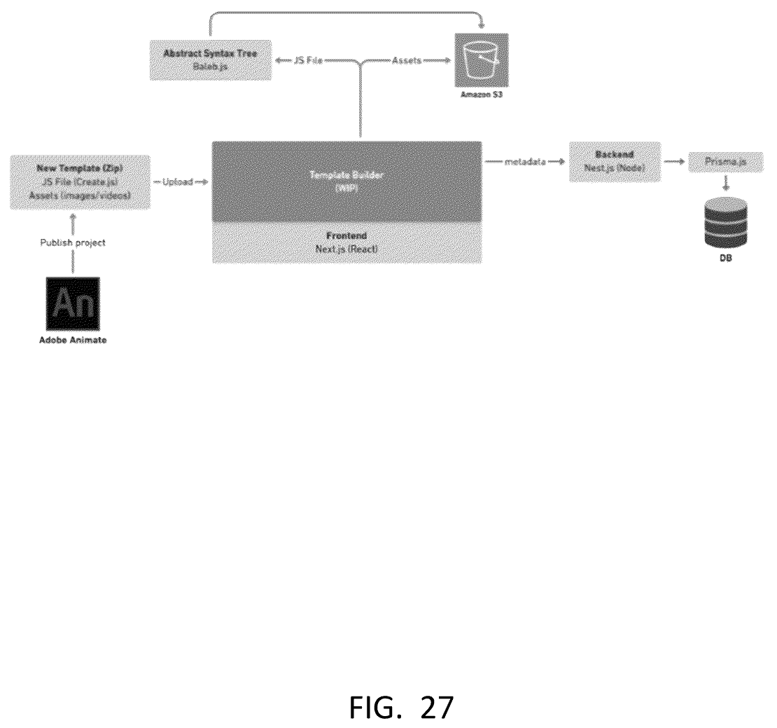

FIG. 27 further demonstrates an optional template creation flow. The designer first introduces a new template into the system. Preferably, the user uploads a JS file, or those that contain Javascript Code. The file is uploaded into the template builder, and the user is enabled to use the front end of the platform. The JS file is taken to the Abstract Syntax Tree, but other data structures can be used. The file is stored using Amazon Simple Storage Service, or another storage software. Meanwhile, the metadata is sent and stored in the backend of the platform. In this embodiment, the data is stored via Nest. JS, to Prisma.js, and housed in a database.

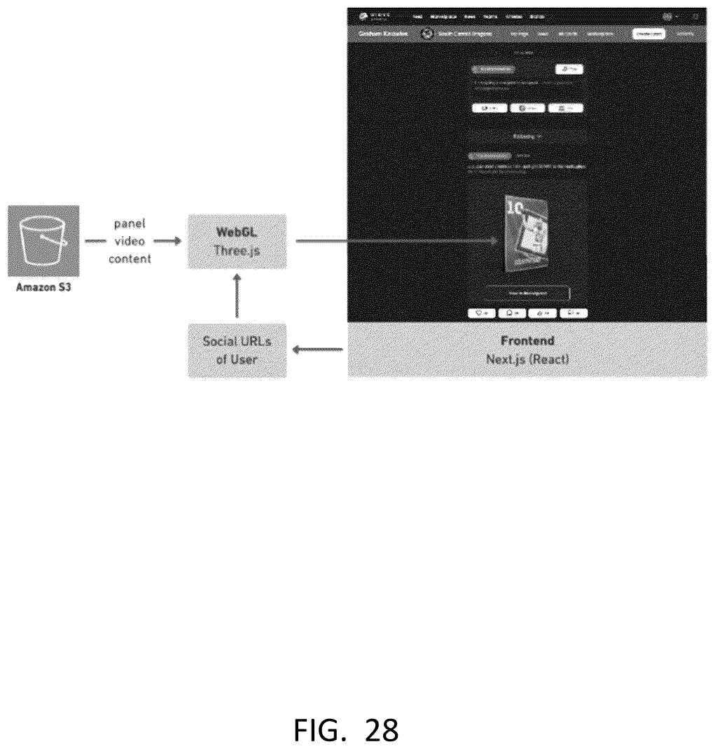

FIG. 28 shows another aspect, which includes card or virtual 3D object display flow. FIG. 28 is one of the areas where an end-user optionally but preferably views a built-out item. FIG. 28 shows the platform using Amazon S3 for the creation and display of Panel Video Content. The data is sent to a library, such as a Web Graphics Library, which is a JavaScript API. The WebGL displays on the front end and also houses the Social URLs of the user.

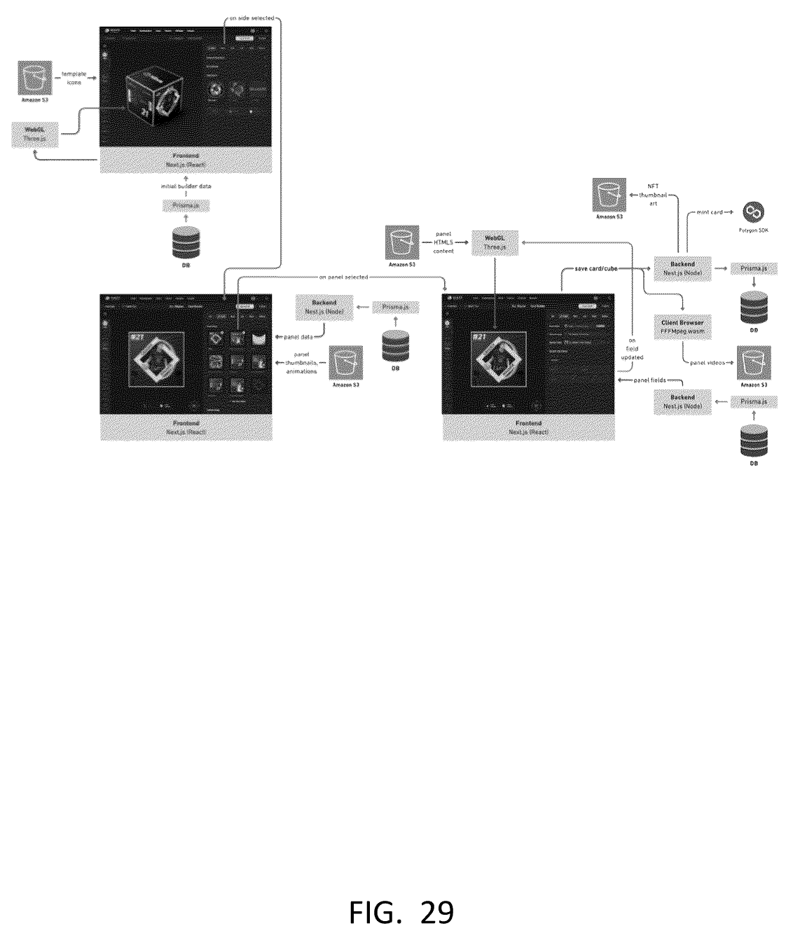

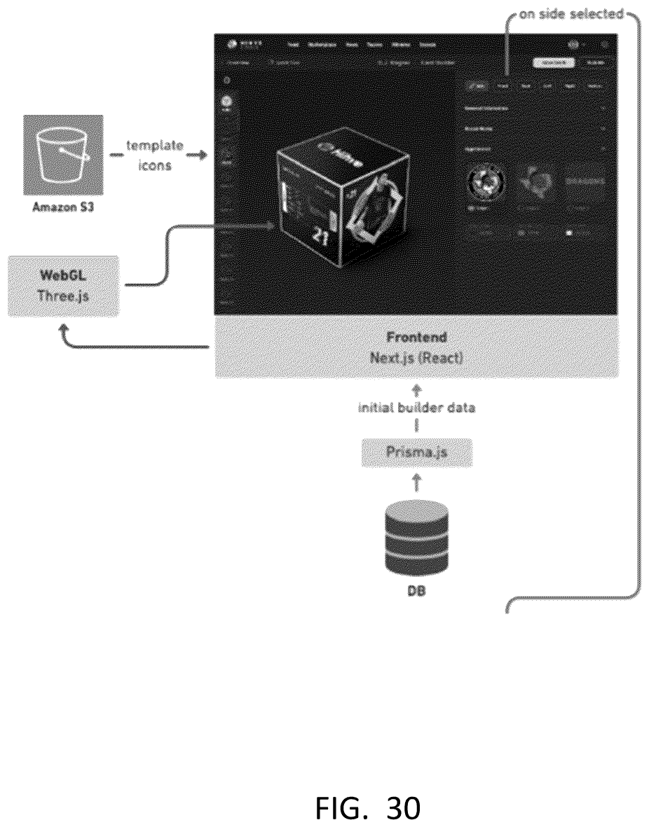

FIG. 29 depicts an aspect of the platform's graphical user interface as it relates to the card builder flow or virtual 3D object builder. In this embodiment, the pathway that an end user might use to create a new virtual 3D object and potentially mint it can be seen. FIGS. 30-32 further depict breakout aspects of FIG. 29. Some of the technologies used in the process may include Next.JS and other modern front-end frameworks that enable server-side rendering and static site generation for React applications. Next.JS (React) can be used to handle the initial rendering, whether its server-side rendered, static, or client side. React components determine the structure and UI of the application.

In FIG. 30, Amazon S3 is used to provide template icons and WebGL is used to assist in rendering high-definition 2D and 3D graphics. The user sees a graphical user interface which optionally but preferably allows the user to select a style for virtual 3D object rendering.

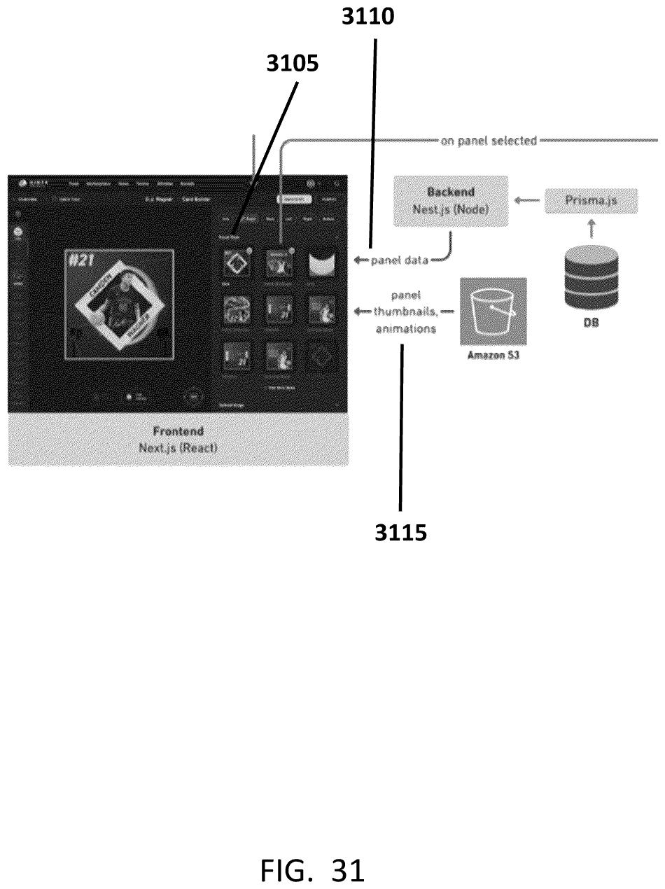

FIG. 31 further shows the user enabled to select a panel style 3105 for use in displaying media. The panel style 3105 is provided via panel data 3110 from the backend in the Nest.JS node which is housed within the database. The user is optionally but preferably provided a panel thumbnail 3115 for facilitating selection of panel style. The panel thumbnail 3115 is rendered via the Amazon S3.

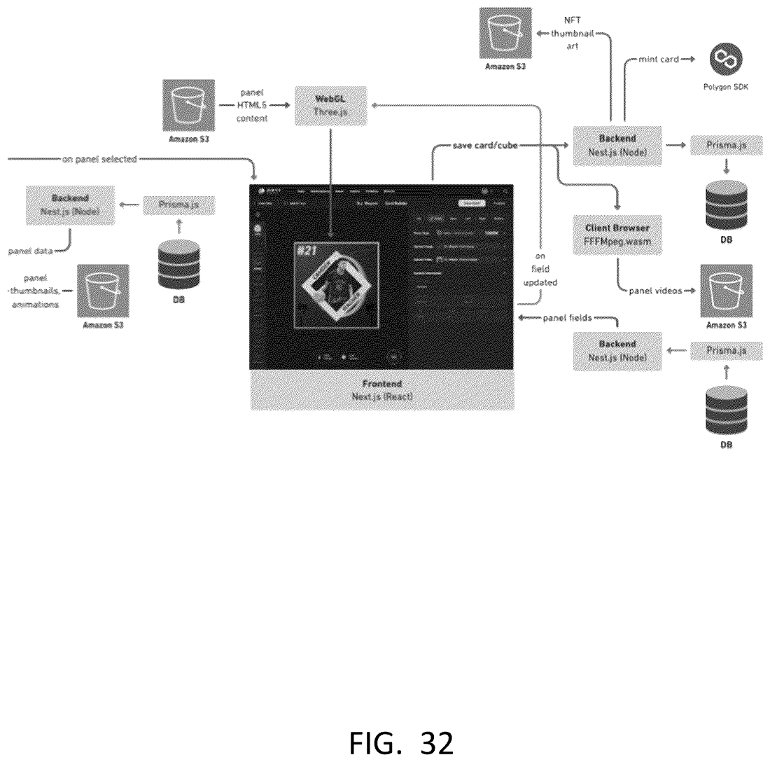

FIG. 32 shows the imagery further populated with panel HTML5 content. From there the user is enabled to save the card or cube, which then is saved on the back end in the Nest.js node. The card is supplied with an NFT thumbnail art facilitated via Amazon S3. The user is then enabled to mint the card, using blockchain supplied by Polygon SDK.

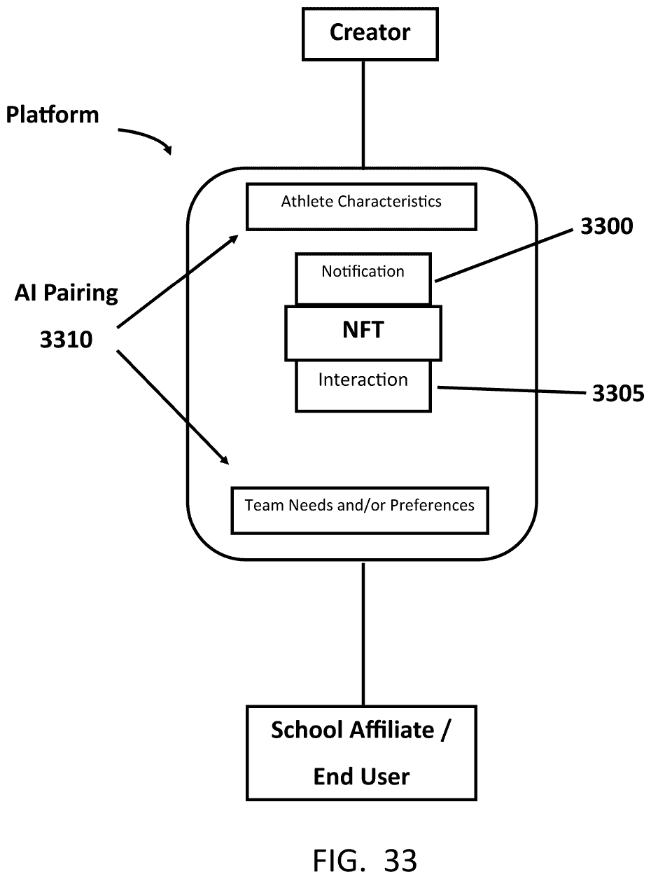

FIG. 33 is a chart showing aspects of optional social network features of the platform. The social media aspect of the platform optionally but preferably allows both players and team affiliates to view media such as NFTs created by the end-user. The end-user will be notified, via notification 3300 concerning interaction 3305 by a team affiliate, scout, or coach.

FIG. 33 shows Artificial Intelligence, or AI pairing 3310. The platform optionally utilizes AI or machine learning to observe athlete characteristics, skills, or traits. For instance, an AI will be programmed to observe a certain characteristic of an athlete, such as a middle linebacker covering crossing routes over the middle of the field in a football game. The AI optionally but preferably observes an athlete's ability to cover crossing routes or inability to cover crossing routes. The AI differentiates this skill from others, such as differentiating a middle linebacker covering crossing routes over the middle of the field, from a middle linebacker covering a running-back one-on-one in the flats or on a wheel route towards the sideline. A team or end-user then optionally but preferably indicates to the platform that the team is seeking a middle linebacker than can cover crossing routes over the middle of the field. The AI of the platform will then search through highlights or gameplay media uploaded by player-users to evaluate whether any show a proficiency in covering crossing routes over the middle of the field. The AI will then implement the AI pairing 3310 feature to show the team affiliate highlights from players proficient at covering crossing routes over the middle of the field. Alternatively, the team affiliate may upload highlights of a player whose skills the team is needing to replace or to recruit similar players for. The platform's AI will then evaluate the highlights from the first player as uploaded by the team affiliate, and then search for highlights from similar plays or skillsets uploaded by end-user recruits to the platform. Similarly, the AI can be used to use data from an athlete or set of athletes as opposed to simply viewing video. This optional feature may be used in recruiting, drafting and/or forming/choosing fantasy sports teams.

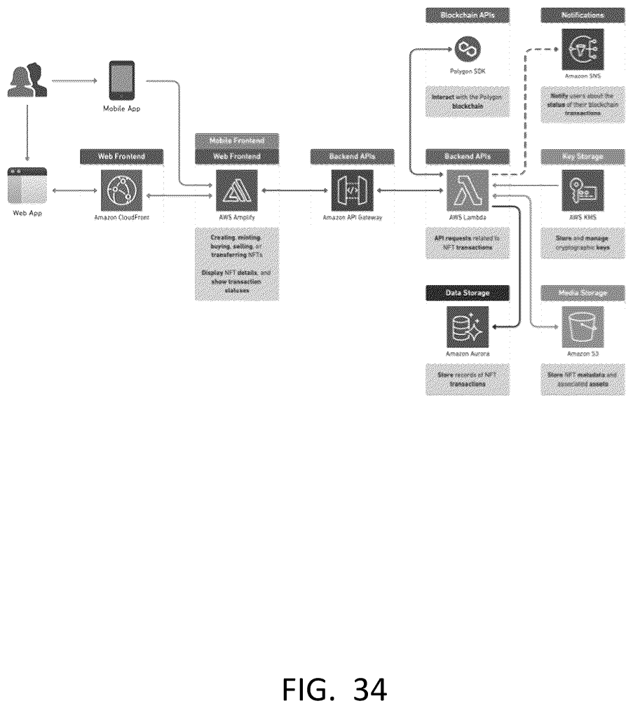

FIG. 34 is a detailed flow chart showing optional social network functionality. The user is optionally but preferably enabled to view the platform via a mobile app or a web app. The web app utilizes a content delivery network such as amazon CloudFront. The web front end allows users to create, mint, buy, sell, or transfer NFTs. The front end uses toolkits such as AWS Amplify to display NFT details and show transaction statuses. The backend optionally uses Amazon API Gateway which interacts with AWS Lambda. The platform further uses polygon to facilitate the use of blockchain for authentication; Amazon SNS to notify users about the status of their blockchain interactions; Key Storage to store and manage cryptographic keys; media storage; and data storage.

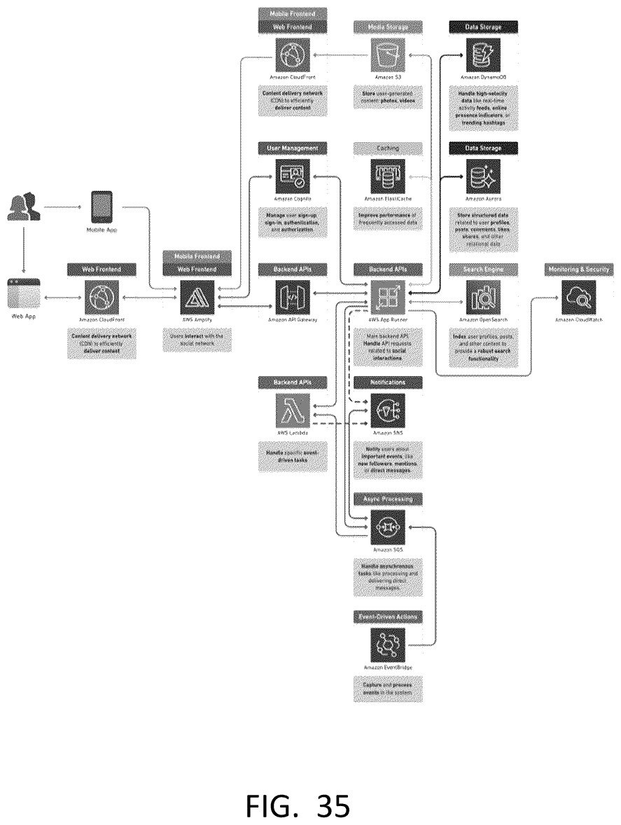

FIG. 35 is a further detailed chart showing optional social network functionality. Users optionally but preferably access the platform through a user interface such as a web front end or mobile app. The user interface (UI) is where users interact with the social network. The platform has User Profiles and Content. The user profile and content can be facilitated through Amazon Aurora to store structured data related to user profiles, posts, comments, likes, shares, and other relational data. Amazon S3 is utilized to store user-generated content such as photos, videos, and other media associated with posts or user profiles. The platform further allows real-time interactions and caching. The platform implements user authentication and management, including via Amazon Cognito to manage user sign-up, sign-in, authentication, and authorization. The platform uses backend processing and APIs, including optionally Amazon API Gateway and Apprunner to handle API requests related to social interactions. The platform allows for search and discovery of NFTs, including via Amazon OpenSearch Service to index user profiles, posts, and other content to provide a robust search functionality. The platform allows for notifications and direct messaging, including via Amazon SNS and Amazon SQS, to notify users about events and handle asynchronous tasks like processing and delivering direct messages. The platform provides monitoring and analytics, including via Amazon Cloudwatch, to monitor the operations and performance of the platform, set alarms for specific conditions, and gather metrics for analysis. The platform further provides content delivery and optimization, including via Amazon Cloudfront, for a content delivery network (CDN) to efficiently deliver content (like images, videos, or even API responses) to users globally with low latency.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

Examples include the following: A graphical user interface for a computer for displaying, inter alia, sports imagery, comprising: A virtual screen. A computer with a memory. In computer memory, at least one virtual object viewable within the screen. The virtual object having at least a virtual first external content surface and a virtual second external content surface which face different directions from each other. The virtual first external content surface has a first sports imagery. The virtual second external content surface has second sport imagery. The virtual object is rotatable by the user in 3D within the viewable area to view different surfaces of the object. During a session, the first external content surface with the first sports imagery is rotated by the user out of view and subsequently rotated back into view the first external content screen changes to replace the first sports imagery with different imagery.

Another example is as follows: A graphical user interface for a computer for displaying sports imagery, comprising: A visual screen. In computer memory, at least one virtual object viewable within the screen, the virtual object having at least a virtual first external content surface and a virtual second external content surface which face different directions from each other. The virtual first external content surface has a first sports imagery. The virtual second external content surface has second sport imagery. The virtual object is rotatable back and forth at least on a Z-axis and on an X-axis by the user in 3D within said viewable area to view different surfaces. In response to user interface movement back and forth generally horizontally said virtual object rotates proportionally around said Z-axis; and, in response to user interface movement back and forth generally vertically said virtual object rotates proportionally around said X-axis.

Further, the graphical user interface discussed above, the rotation about the Z-axis and the X-axis and the Y-axis may optionally be accomplished with a sinusoidal function.

A graphical user interface for a computer for displaying sports imagery, comprising: a visual screen; in computer memory at least one virtual object viewable within the screen, the virtual object having at least a virtual first external content surface and a virtual second external content surface which face different directions from each other. The virtual first external content surface has a first sports imagery. The virtual second external content surface has second sport imagery; virtual object is rotatable back and forth at least on a Z-axis and on an X-axis by the user in 3D within said viewable area to view different surfaces; wherein in response to user interface movement back and forth generally horizontally said virtual object rotates proportionally around said Z-axis; and, wherein in response to user interface movement back and forth generally vertically said virtual object rotates proportionally around said X-axis.

In another example, the graphical user interface [above] wherein the virtual object is derived from a creation system in computer memory; wherein said creation system includes: (a) at least two templates of virtual objects in 3D shapes to select and deploy in the graphical user interface; and (b) at least two receptacles of data to deploy at least two items of sport imagery respectively on two surfaces of the virtual object.

In another example, the graphical user interface [above] wherein the first sports imagery is substantially 2-D in appearance and upon the rotation about an axis, the first sports imagery is proportionally distorted to be digitally compressed in a direction perpendicular to the axis, the proportional compression being non-linear and being a sine function of the magnitude of rotation.

In another example, the graphical user interface [above], wherein rotation of the virtual object about an axis is inertial rotation whereby an interface movement followed by interface release results in continuation of the rotation for at least 45 degrees of rotation about the same axis after the release.

In another example, the graphical user interface [above], wherein the first external content surface and the second external content surface are connected to one another across a fixed axis directly or via the virtual object; wherein the virtual object is smoothly rotated by the user such that the rotation is initiated by and is proportional to the movement of a user interface. The user interface selected from the group comprising: user digit on a touch screen, mouse, stylus on a touch screen, user hand movement connected to goggles.

According to another example, the graphical user interface [above], wherein the first external surface has a first opacity. The second surface has a second opacity that is different than the first opacity. In some embodiments, the second surface interface has a second opacity that is substantially transparent.

In another example, in the graphical user interface [above], the first external surface has a first opacity; and the second surface has a second opacity that is different than the first opacity. At least one external surface face has an interactive component comprising a hyperlink. A second virtual object that forms a 3D object within the inside of the first virtual object.

In some examples, in graphical user interface [above], the first virtual object is selected from the group comprising a 3D: cube, cuboid, hexagonal prism, pentagonal prism, rectangular prism, triangular prism, cylinder, pyramid, octahedron, dodecahedron, and tetrahedron. The sports imagery is selected from the group comprising in computer memory: photograph, video, hyperlink, text, numeric information, icon, logo, drawing, and cartoon. The visual screen is selected from the group comprising: flat screen, curved screen, computer projector and computer goggles. The virtual object comprises at least one NFT. The sports imagery is dynamically linked to an external data source to update information in the imagery.

In other examples, in graphical user interface [above], the virtual object is derived from a creation system in computer memory. The creation system includes: (a) at least two templates of virtual objects in 3D shapes to select and deploy in the graphical user interface; and (b) at least two receptacles of data to deploy at least two items of sport imagery respectively on two surfaces of the virtual object. The creation system in computer memory includes at least two selectable output types to manage file data size and file format for different visual screen hardware and software.

### DEFINITIONS

The language used in the present disclosure is to only have its plain and ordinary meaning, except for terms explicitly defined below. Such plain and ordinary meaning is defined here as inclusive of all consistent dictionary definitions from the most recently published (on the filing date of this document) general purpose Merriam-Webster dictionary.

As used herein, the following terms have the following defined meanings:

Dynamically—Dynamically and/or dynamic means moving or changing in response to another input.

Imagery—Imagery means and includes pictures, drawings, videos, sounds, memes, photos, links, videos, GIFs, colors, text, logos, trademarks, symbols, and/or words.

Inertia—Inertia or inertial means something that is caused by, using, or relating to an object or entity's propensity to continue movement in the same direction (linear or rotation).

Media—Media means imagery stored in computer memory.

Rotatable—Rotatable means an object or image or data which appears to move or is capable of moving about an axis or from one position to another. A rotatable object can change fixed positions. Rotatable may mean that a user causes a rotation or that a rotation is programmed within the graphical user interface.

Rotation—Rotation means an action of changing, including changing position, changing of nature such as switching images or sequences, rotating about an axis.

Session—Session means the use of a program or media, including use on a computer or computer program. Sessions can occur online or offline.

Screen—Screen means a fixed or movable portion of or from an electronic device which visually shows imagery. A screen can be part of a mobile device, a desktop device, a projector, a TV screen, a monitor, a “hologram”, or other visual or data imagery devices.

Sinusoidal function—Sinusoidal function means virtual dynamic rotation of a virtual object in response to a generally linear swipe where by the rotational speed is at a non-linear sine wave speed in response to a generally linear speed of the swipe.

Smooth—Smooth means without stopping and starting, without perceived unnecessary abruptness.

Surface—Surface means a layer, wall, or portion of an object. Surface can be in the outside layer or an inside layer. Surfaces can have texture or be transport or translucent. Surfaces may appear flat, curved or contoured.

Swipe—swipe means a linear or generally linear movement of a user finger or user controlled cursor, pointer and/or other object on or depicted in a screen.

Viewable—Viewable means visible, potentially visible, discernable, or inspectable. An object may be viewable automatically, as caused by the user, or as caused by the graphical user interface.

Virtual—Virtual means being on or simulated on a computer or computer network.

What is claimed is:

1. A graphical user interface for a computer for displaying sports imagery, comprising:
a visual screen;
in computer memory at least one virtual object viewable within said screen, said virtual object having at least a virtual first external content surface and a virtual second external content surface which face different directions from each other;
wherein said virtual first external content surface has a first sports imagery;
wherein said virtual second external content surface has second sport imagery;
virtual object is rotatable by the user in 3D within said viewable area to view different surfaces.
wherein rotation of said virtual object is by a sinusoidal function.

2. The graphical user interface of claim 1, wherein rotation has rotational inertia of said object.

3. The graphical user interface of claim 1, wherein said first sports imagery is substantially 2-D in appearance and upon said rotation about an axis said first sports imagery is proportionally distorted to be digitally compressed in a direction perpendicular to said axis, said proportional compression being non-linear.

4. The graphical user interface of claim 1, wherein rotation of said virtual object about an axis is inertial rotation whereby an interface movement followed by interface release results in continuation of said rotation for at least 45 degrees of rotation about said same axis after said release.

5. The graphical user interface of claim 1, wherein said the first external content surface and the second external content surface are connected to one another across a fixed axis directly or via said virtual object;
wherein said virtual object is smoothly rotated by the user such that the rotation is initiated by and is proportional to the movement of a user interface, said user interface selected from the group comprising: user digit on a touch screen, mouse, stylus on a touch screen, user hand movement connected to goggles.

6. The graphical user interface of claim 1, wherein said first external surface has a first opacity; and
wherein said second surface has a second opacity that is different than said first opacity.

7. The graphical user interface of claim 6, wherein said second surface has a second opacity that is substantially transparent.

8. The graphical user interface of claim 7, wherein said virtual object forms a 3D shape with a plurality of external surfaces, and wherein an inside of said 3D shape is viewable from at least one perspective of rotating said virtual object for viewing of at least one internal surface inside of said 3D shape.

9. The graphical user interface of claim 1 in which at least one external surface face has an interactive component comprising a hyperlink.

10. The graphical user interface of claim 1 and further comprising a second virtual object that forms a virtual 3D object within said inside of said first virtual object.

11. The graphical user interface of claim 1, wherein said first virtual object is selected from the group comprising 3D: cube, cuboid, hexagonal prism, pentagonal prism, rectangular prism, triangular prism, cylinder, pyramid, octahedron, dodecahedron, and tetrahedron.

12. The graphical user interface of claim 1, wherein said sports imagery is selected from the group comprising in computer memory: photograph, video, hyperlink, text, numeric information, icon, logo, drawing, and cartoon.

13. The graphical user interface of claim 1, wherein said visual screen is selected from the group comprising: flat screen, curved screen, computer projector and computer goggles.

14. The graphical user interface of claim 1, wherein said first virtual object comprises at least one NFT.

15. The graphical user interface of claim 1, wherein at least one sports imagery is dynamically linked to an external data source to update information therein.

16. The graphical user interface of claim 1, wherein the virtual object is derived from a creation system in computer memory;
wherein said creation system includes:
(a) at least two templates of virtual objects in 3D shapes to select and deploy in the graphical user interface; and
(b) at least two receptacles of data to deploy at least two items of sport imagery respectively on two surfaces of said virtual object.

17. The graphical user interface of claim 1, wherein said creation system in computer memory including at least two selectable output types to manage file data size and file format for different visual screen hardware and software.

18. A graphical user interface for a computer for displaying sports imagery, comprising:
a visual screen;
in computer memory at least one virtual object viewable within said screen, said virtual object having at least a virtual first external content surface and a virtual second external content surface which face different directions from each other;
wherein said virtual first external content surface has a first sports imagery;
wherein said virtual second external content surface has second sport imagery;
virtual object is rotatable back and forth at least on a Z-axis and on an X-axis by the user in 3D within said viewable area to view different surfaces;
wherein in response to user interface movement back and forth generally horizontally said virtual object rotates proportionally around said Z-axis; and,
wherein in response to user interface movement back and forth generally vertically said virtual object rotates proportionally around said X-axis.

19. A graphical user interface for a computer for displaying sports imagery, comprising:
a visual screen;
in computer memory at least one virtual object viewable within said screen, said virtual object having at least a virtual first external content surface and a virtual second external content surface which face different directions from each other;
wherein said virtual first external content surface has a first sports imagery;
wherein said virtual second external content surface has second sport imagery;
virtual object is rotatable by the user in 3D within said viewable area to view different surfaces.
wherein during a session said first external content surface with said first sports imagery is rotated by the user out of view and subsequently rotated back into view said first external content screen changes to replace said first sports imagery with different imagery.

20. The graphical user interface of claim 19, wherein said first external surface has a first opacity; and
wherein said second surface has a second opacity that is different than said first opacity;
wherein said second surface has a second opacity that is substantially transparent, wherein said virtual object forms a 3D shape with a plurality of external surfaces, and wherein an inside of said 3D shape is viewable from at least one perspective of rotating said virtual object for viewing of at least one internal surface inside of said 3D shape.
